(19) United States
(12) Patent Application Publication
(10) Pub. No.: US 2006/0288024 A1
(43) Pub. Date: Dec. 21, 2006

(54) Compressed representations of tries

(75) Inventor: Philip R. Braica, New Boston, NH (US)

Correspondence Address: GORDON E. NELSON, PATENT ATTORNEY, PC, 57 CENTRAL STREET, P.O. BOX 782, ROWLEY, MA, 01969, US

(73) Assignee: Freescale Semiconductor Incorporated

(21) Appl. No.: 11/116,788

(22) Filed: Apr. 28, 2005

(51) Int. Cl. G06F 7/00

(52) U.S. Cl. 707/101

(57) ABSTRACT

Techniques for representing nodes of tries. Associated with the nodes are keys and rules. A node of a trie having a stride n>1 is represented by a trie having a stride of 1 and the stride 1 trie is represented by a bit string termed a structural enumeration. The structural enumeration has a bit for each node of the trie of stride 1. If the node has a key and rule associated with it, the bit is set; otherwise it is not. The representation of a node of stride n>1 includes the node's structural enumeration and an array of rule pointers. The array has an entry for each rule associated with the node and the entries have the same order in the array as the set bits for their keys in the structural enumeration. Nodes having large strides may be represented by subdividing them into subtries.

### CROSS REFERENCES TO RELATED PATENT APPLICATIONS

The subject matter of this patent application is closely related to the subject matter of patent application U.S. Ser. No. ______, Method and Apparatus for finding a perfect hash function and making a minimal hash table for a given set of keys, which has the same inventor and assignee as the present patent application and is being filed on even date with this application. U.S. Ser. No. ______, is further incorporated by reference into this patent application for all purposes.

### BACKGROUND OF THE INVENTION

1. Field of the Invention

The invention relates generally to compressed representations of tries and more particularly to compressed representations of tries for use in packet switches and routers.

2. Description of Related Art: FIGS. 1-3

Tries: FIG. 1

A common activity in any kind of information processing is using a key to find a piece of information. One very simple example of this operation is using a word to find the word's definition in a dictionary. The dictionary arranges the definitions according to the alphabetic order of the words they define, and thus the word can be used as a key to find the definition.

In the world of digital data processing, a common way of using a key to find data is to apply the key to a trie. FIG. 1 shows a trie 107 that is used to locate rules 105 that apply to certain combinations of bits in a three-bit key portion 109. In the terminology used to describe tries, trie 107 is a trie for an alphabet consisting of three-bit bit strings: 000, 001, . . . , 110, 111. At the highest level trie 107 contains a single node 111 of stride 3, i.e., the node takes a three-bit key portion 109 as input and produces as output for the bit string either one of a number of rules 105(1 . . . 3) or nothing, as indicated by null 113. Conceptually, node 111 contains 15 nodes 103 of stride 1, numbered 103(0) through 103(14). Node 103(0) is the root node; the remainder of the nodes indicate possible values of the bit string. x indicates a “don't care” bit. Starting at the root node, if the leftmost bit of the three-bit string is 0, the part of the trie that is of interest is node 103(1) and its descendants; if the leftmost bit of the three-bit string is 1, the part of the trie that is of interest is node 103(2) and its descendants. Next, the middle bit of the string is dealt with, as shown in nodes 3-6; finally, the last bit is dealt with, as shown in nodes 7-14. There are three rules: rule 105(1) applies to node 2 and its descendants, i.e., whenever the leftmost bit of the string is 1; Rule 105(2) applies to node 3 and its descendants, i.e., whenever the leftmost two bits are 00; Rule 105(3), finally, applies only to node 11, i.e., when the three bits are 100. As may be seen from the above, to determine what rule applies to a given node in trie 101, one first determines whether the given node has a rule of its own; if not, the given node inherits its rule from its closest ancestor node to have a rule. Thus, the nodes subject to rule 105(1) are 2, 5, 6, 12-14; those subject to rule 105(2) are 3, 7, 8, and the only node subject to rule 105(3) is node 11.

An important characteristic of trie 101 is that each rule appears only once in the trie. In the following, such tries are termed perfect with regard to the rules. A trie is perfect if each rule appears only once because the index of the rules is mathematically a perfect hash function. If the rules are listed more than once, additional space is required. A perfect trie that is sufficiently small to have a reasonably-sized representation can be thought of as minimal because the representation permits a minimal hash function or software expression to be associated with the perfect trie. For a given perfect trie, there can be a number of equivalent non-perfect tries. For example, as is clear from the inheritance rules, a trie in which rule 105(1) was associated with nodes 12-14, rule 105(2) was associated with nodes 7-8 and rule 105(3) with node 11 would be equivalent to trie 101. Further important terminology for describing tries includes the following: The trie's leaf nodes are nodes that have no descendants; here, nodes 7-14; nodes with descendants are termed interior nodes. Levels of nodes are determined by the distance of the node from the root, which is level 0. Consequently, nodes 1 and 2 belong to level 1, nodes 3-6 belong to level 2, and nodes 7-14 belong to level 3. The number of nodes in a level with level number l is 2^{l}.

Tries and Network Routing: FIGS. 2 and 3

One area in which tries are commonly used is routing in packet networks. FIG. 2 shows a schematic diagram of a switch 201 that is used to route packets in a network. Switch 211 is connected to physical media such as cables or wireless links over which packets of data may be transmitted. From the point of view of the switch, the physical media provide a set of input ports 203(0 . . . m) upon which the switch may receive packets and a set of output ports 205(0 . . . n) upon which the switch may transmit packets. Of course, in most cases, the physical media are bi-directional, and an input port 203(i) and an output port 203(j) may correspond to the same physical medium.

Switch 201's function is similar to that of a mail sorter in the post office: The mail sorter takes mail that is coming into the post office, either from patrons of the post office or from other post offices, and sorts it according to each item's address into bundles that are directed to the patrons or to other post offices. In the switch, each packet received in the input ports 203 has a bit string that represents an address, and the switch reads the address and outputs the packet to an output port 205(i) that will take it to its destination. To do the routing, switch 201 employs a routing trie 209 that is contained in memory 207 accessible to the switch. The keys that are applied to routing trie 209 are the packet addresses; a rule indicates which output port 205(i) a packet whose packet address has a given bit pattern is to be output to.

The use of tries to route packets is complicated by a number of factors: first, packet addresses have a good many bits, ranging presently from 32 through 64 bits and in the future, 128 bits. A few applications currently use keys as large as 320 bits. Because of the large number of bits, trie 209 is necessarily very large. Further, the routing rules are complicated and change constantly to reflect changing conditions in the network; a switch may have 10,000 to 250,000 rules and is constantly revising the rules in response to network behavior. Finally, routing must be done quickly. In applications like internet telephony, there are real-time limits on the length of time it takes a packet to traverse the network; even where such constraints do not exist, the longer it takes to route a packet, the larger the buffers that are necessary to hold packets awaiting routing.

To deal with these complications, a switch 201 typically has the internal design shown in FIG. 2: processor 211 is connected to input interface 215, which receives packets from the input ports 203, output interface 213, to which processor 211 outputs packets for output to output ports 205, slower memory 205, which contains routing trie 209, and high-speed memory 207, which contains compressed representations 219(0 . . . k) of parts of trie 209. The compressed representations are representations which take up less memory and require fewer memory references for routing than trie 209 and which therefore permit faster routing. FIG. 3 shows two currently-used compressed representations 219 of a part of trie 209. In flat compressed trie representation 300, for each node of the part of trie 209 represented by representation 219, there is an entry 303 in rule pointer array 301. The entries are indexed by the binary value of the part of the address bit string that the part of the trie is processing. If there is a rule associated with a node, the node's entry contains a pointer to the associated rule. Each entry contains a pointer to an entry in rule array 305 which contains the rule that is associated with to the node to which the entry in rule pointer array 301 corresponds. To find the rule that applies to the node, switch 201 uses the node's bit string to index rule pointer array 301 and uses the pointer in the entry to locate the applicable rule in rule array 305. Because pointers are used in rule pointer array 301, when the relationship between a rule and a node changes, all that need be done is make whatever changes are necessary in rule array 305 and then set the pointer for the node in rule pointer array 301 to the new rule for the node. In general, changes are made in routing as follows: first, routing trie 209 is changed to reflect the changes; then the changes are propagated to the compressed trie representations.

Flat compressed representation 300 is perfectly useful for small keys. If there are n bits in the key, then rule pointer array 301 requires 2ⁿ entries. Thus, if the key is 3 bits long, 8 entries are required. However, the smallest keys which are presently in general use are 32 bits long. With this size of key, you need 2³² entries in rule pointer array 301, that is, 4 gigabytes of memory for array 301. The solution presently employed for larger keys is the index tree compressed representation shown at 313. In this representation, rule pointer array 301 is replaced by a tree of index nodes 315. The root node in this example has four entries, one for bits 0 . . . 7 of a 32-bit key, one for bits 8-15, and so on. Each entry contains a pointer to a further index node 315 that further subdivides the 8 bits that node is to deal with. Eventually, the leaf nodes of index tree 313 are reached, and these contain the rule pointers 303. An advantage of this scheme is that there need not be entries in the index tree for bit patterns which have no rules associated with them. The disadvantage, of course, is that multiple memory references are required to traverse index tree 313 to find the rule pointer. Another disadvantage is that changes in routing trie 209 may require rebuilding of index tree 313 as well as changes in what rules the rule pointers 303 point to. Of course as the sizes of the keys increase, the size of index tree 313 increases, and that in turn results in an increase in the number of memory references required to traverse the tree and an increase in the complexity of maintaining index tree 313.

What is needed if switches and routers are to cope successfully with addresses of ever increasing length is techniques for producing compressed tries that are scalable, i.e., which continue to provide fast access to rules and remain easy to manage as the size of the address increases. It is an object of the invention disclosed herein to provide such techniques for producing scalable compressed tries. Other objects and advantages will be apparent to those skilled in the arts to which the invention pertains upon perusal of the following Detailed Description and drawing, wherein:

### BRIEF DESCRIPTION OF THE DRAWING

FIG. 1 shows a trie with rules;

FIG. 2 is a conceptual drawing of a packet switch that employs a trie for routing;

FIG. 3 is shows prior-art compressed representations of tries;

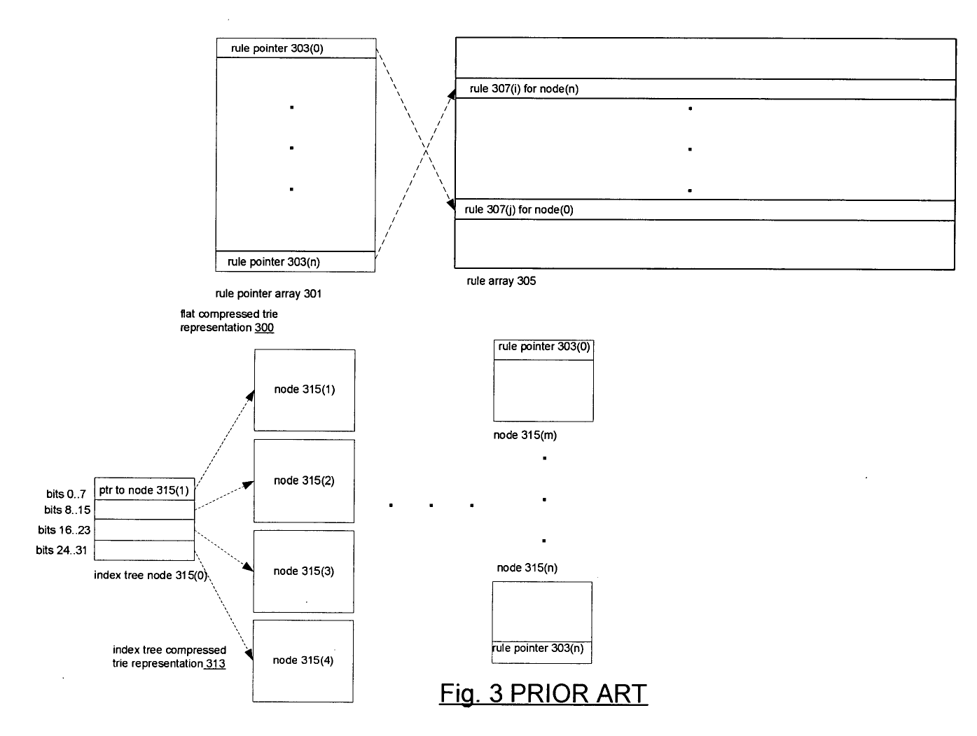

FIG. 4 shows a perfectly-compressed representation of a structural enumeration of a trie;

FIG. 5 shows C code for encoding a perfectly-compressed representation of a structural enumeration;

FIG. 6 shows C code for decoding a perfectly-compressed representation of a structural enumeration;

FIG. 7 shows how the set of structural enumerations for a trie may be transformed into a smaller but equivalent set of effective enumerations;

FIG. 8 is a table showing the sizes of the set of structural enumerations and the equivalent set of effective enumerations for tries having various strides;

FIG. 9 shows a perfectly compressed representation of an effective enumeration of a trie;

FIG. 10 shows how imperfect compression may be used to reduce the size of a set of effective enumerations;

FIG. 11 shows further examples of imperfect compression;

FIG. 12 shows functions for computing the number of effective enumerations needed for perfect compression and the number of structural enumerations needed;

FIG. 13 shows a function for making a set of effective enumerations of a certain size;

FIG. 14 shows how a trie having a large stride may be subdivided into a set of tries having smaller strides;

FIG. 15 shows a compressed representation of such a trie;

FIG. 16 shows a compressed representation of a trie that uses a rule vector table;

FIG. 17 shows a compressed representation of a trie with imperfect compression; and

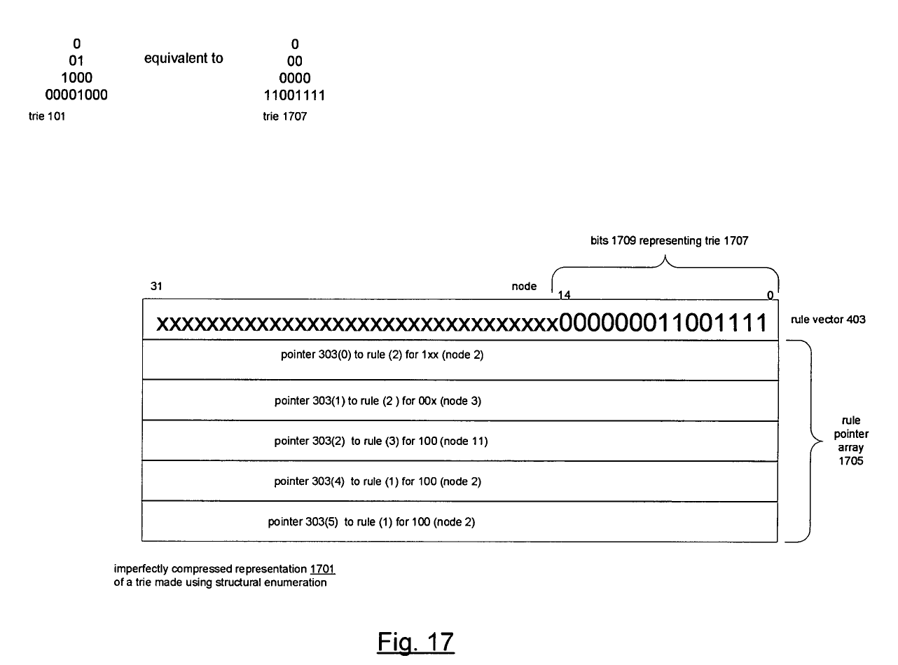

FIG. 18 illustrates how it may be determined whether a node is redundant.

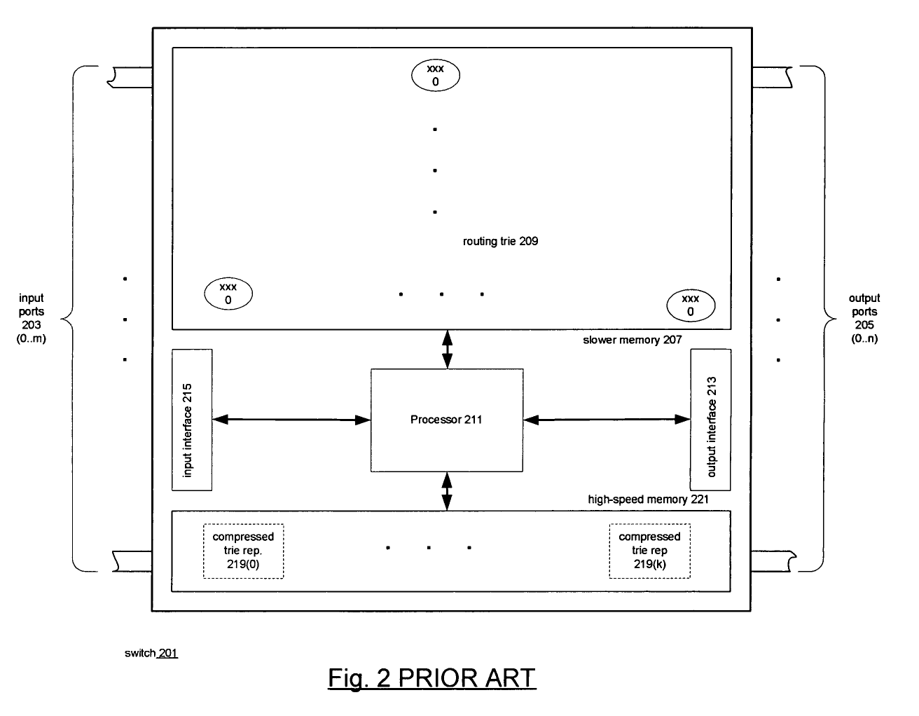

Reference numbers in the drawing have three or more digits: the two right-hand digits are reference numbers in the drawing indicated by the remaining digits. Thus, an item with the reference number 203 first appears as item 203 in FIG. 2.

### DETAILED DESCRIPTION

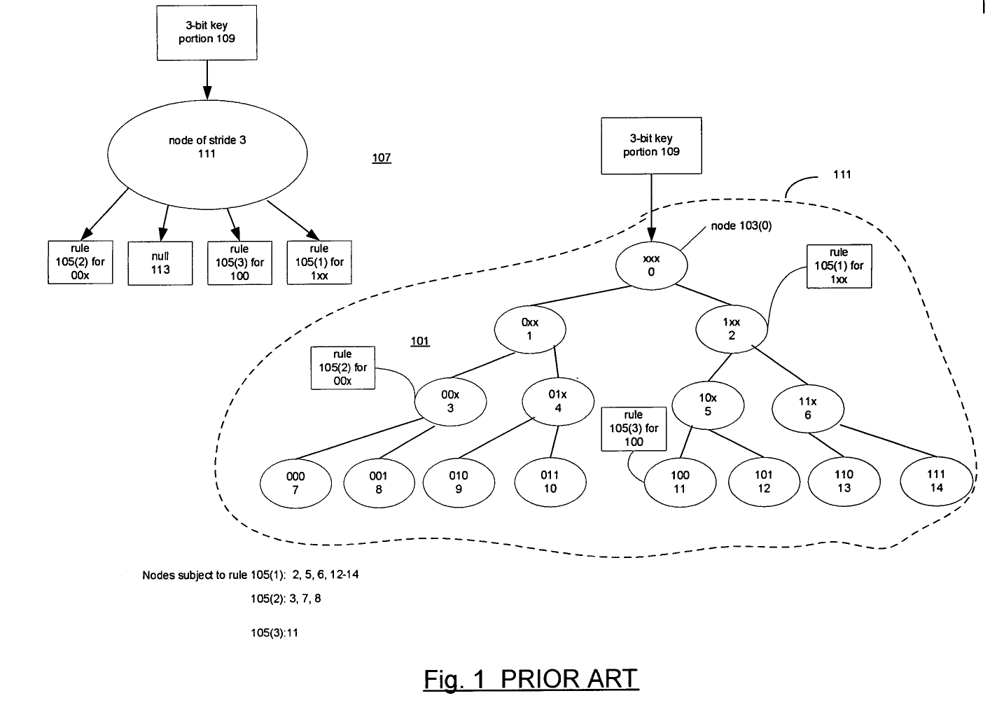

The following Detailed Description will first describe how to make a structural enumeration of a single-stride trie and how to use the structural enumeration to make a perfectly-compressed representation of a trie like that shown in FIG. 1. The representation is perfectly compressed because it is made from a perfect trie and has only one rule pointer for each rule in the trie. Then the Detailed Description will show how structural enumerations may be equivalent to each other and how the equivalence of structural enumerations may be used to make a given set of structural enumerations into a smaller equivalent set of effective enumerations and will disclose how to make perfectly compressed representations of tries using sets of effective enumerations. The Detailed Description will further show how the size of the set of effective enumerations may be still further reduced by making compressed representations with imperfect compression, i.e., the compressed representation is made from an imperfect trie and therefore may have more than one rule pointer for a given rule. Finally, it will describe how tries with larger strides can be compressed by splitting them into subtries and compressing the subtries.

The description here is a recipe for creating an embodiment of the invention. It starts by showing the theoretical ground work of the invention. The table system will consist of a set of memory locations, each represents a node, and software and or hardware starts at each node and moves to the next until it finds a best matching rule. The goal is to create a system where the amount of memory for each node is smallish and conveniently sized. The design for the node balances a need to completely describe all possible nodes attached below it in great detail, and being small enough that it is easy for hardware to quickly fetch and store for fast processing. The balance differs greatly with different systems. If 128 bits of memory can be quickly fetched, the question becomes how deep a stride node can be described in that many bits, and how accurately. If it can always describe the pointers to the nodes below it with perfect accuracy, listing each pointer once, it is a perfect trie. The goal of an embodiment is to have a system that for each node usually describes the pointer list perfectly, or nearly perfectly such that it wastes very little memory while offering the largest strides possible for each node. This way there are fewer nodes to process to find a rule for a given key.

The section on structural enumeration describes how to write down a single number (for a node of any stride) that completely describes how to index to the next node with a perfect hash function. It redefines the problem from how do we describe an index system to how do we compress that description practically. For a node that has a stride of 8 it takes 8 key bits to compute which next node to get to. Up to 256 different nodes or just a few nodes indexed to multiple times might need to be described. Structural enumeration names these configurations by number. The number is always 0 to 2ˆ(2ˆstride−1). That means for an 8 bit stride node, 256 bits must be reserved to be able to name each possible mapping.

The section on effective enumeration notes that several different structural enumerations may be identical in practice. This in turn significantly reduces the number of node configurations that must be uniquely identified. It also specifies the algorithm to determine what the set of effective enumerations are for a node of a given stride, and how to then score each effective enumeration in terms of how often it is used.

The Detailed description then describes how to select some of the effective enumerations to become the chosen alphabet for a given type of node needed by an embodiment such that:
the alphabet is small enough to write down a node description in a piece of memory of convenient size, thereby minimizing memory and processing time;
the alphabet is powerful enough to permit large strides; and
the alphabet often comes very close to perfectly describing the the topology of a node, so that only a small percentage of extra copies of rule pointers are required.

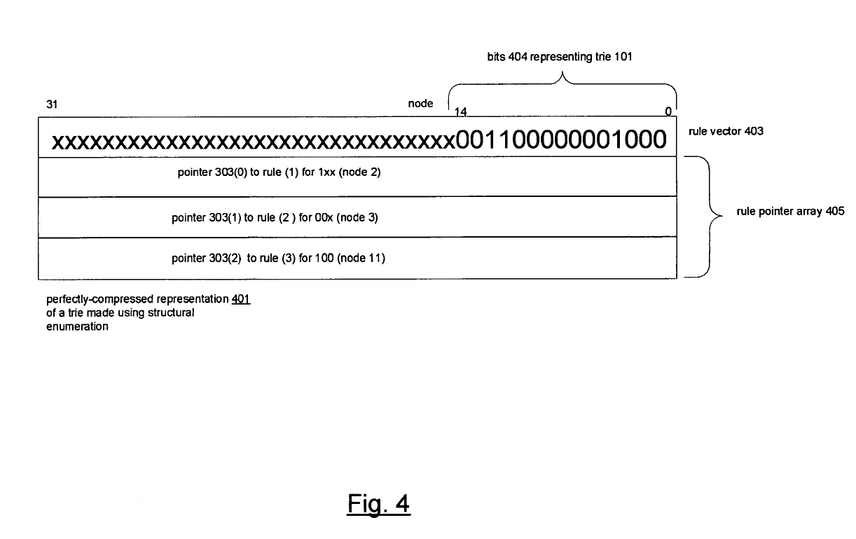

Compressed Representations of Tries That Use Rule Vectors: FIGS. 4-7

Structural Enumeration

Trie 101 of FIG. 1 has a node for each possible form of the bit string which is the index that is applied to the trie and the nodes are ordered with the nodes for the msb at the first level of the trie, the nodes for the first two msbs at the second level, and so on until the leaf nodes are reached, which are nodes for all of the bits of the key. Each of the nodes may have a rule associated with it. When a node has a rule associated with it, that is indicated in the node. Since each of the nodes in the trie may have a rule associated with it, there may be 15 rules associated with trie 101 and 127² different combinations of nodes with rules and nodes without rules. Each of these combinations of nodes with rules and nodes without rules is termed in the following a structural enumeration of the trie and the 127² different combinations make up the set of structural enumerations that may be associated with a node of stride 3. If a trie is perfect, its structural enumeration is a perfect structural enumeration; the structural enumeration of an imperfect trie is called an imperfect structural enumeration. Stated broadly, a structural enumeration is a string which has a symbol corresponding to each node in the trie. The symbol corresponding to a given node has a first setting if there is a rule associated with the given node; otherwise, it has a different setting.

In the following, structural enumerations of tries of stride 1 will be represented as rule patterns having the form x xx xxxx . . . , where each x represents a node and spaces separate levels of the nodes. If a node has a rule associated with it, it is represented in the string by the value “1”; otherwise, it is represented by the value “0”. As a rule pattern, the structural enumeration of trie 111 has the form 0 01 1000 00001000. As can be seen by the foregoing, a structural enumeration may be represented by a string in which there is a predetermined mapping between nodes of the trie of stride 1 and characters in the string, with the value of the character corresponding to a node indicating whether the node has a rule. For example, the structural enumeration of trie 111 may be represented by the bit string ‘001100000001000’.

A Perfectly-Compressed Representation of a Trie That Employs Structural Enumeration: FIG. 4

FIG. 4 shows a perfectly-compressed representation of structurally-enumerated trie 101 that is made using the trie's structural enumeration. The representation consists of one memory word that holds a rule vector 403 that contains the trie's structural enumeration and a rule array 405 that has as many other memory words as are necessary to hold pointers to the rules belonging to the trie. For trie 101, rule vector 403 has 15 bits of interest, one representing each node of trie 101. The other bits are don't care bits. If a node has a rule associated with it, the bit representing the node is set; otherwise it is not; thus, trie 101 has rules associated with nodes 2, 3, and 11, and in rule vector 403, bits 3, 4, and 12 are set (reading from left to right with the leftmost bit representing node 0). Because trie 101 has three rules associated with it, there are three rule pointers in rule array 405. The rule pointers are ordered in rule array 405 in the same way that the set bits indicating the rules are ordered in rule vector 403; thus, the pointer for the rule for node 2 is the first pointer in rule array 405, the pointer for the rule for node 3 is the second pointer in array 405, and the pointer for the rule for node 11 is the third pointer. Representation 401 is perfectly compressed because trie 101 is a perfect trie. Consequently, each individual rule in the trie is associated with only one node and there is therefore only one pointer to the individual rule in compressed representation 401.

Compressed representation 401 may be used to find what rule applies to one of the three-bit keys that are applied to trie 101 as follows:
1. The value of the three-bit key is used to find the number of the leaf node for the three-bit key;
2. The inheritance rules and rule vector 403 are used to determine which of the rules apply to the leaf node;
3. the position of the 1 bit for the rule in rule vector 403 determines which pointer in rule array 405 points to it.

Thus, if the three-bit key is 001, the node corresponding to the key is node 8 and the bit that represents the node for the key in rule vector 403 is bit 8; the nodes which may include rules that apply to node 8 are nodes 0,1,3, and 8; on examining the bits for these nodes in rule vector 403, it is apparent that the rule that applies is the rule for node three; ordered by the numbers of the nodes the rules belong to, this is the second rule in rule vector 403 and thus pointer 303(1) in rule array 405 is the pointer to the rule that applies to the node. As is apparent from the above, only three memory references are needed to find the rule: one to rule vector 403, one to the proper pointer in rule array 405, and one to the rule identified by the pointer. Moreover, the number of memory references remains constant regardless of the number of rules. Finally, the total space in memory required for compressed representation 401 is the word required for rule vector 403 plus the number of words required for rule array 405.

An advantage of compressed representation 401 is that it may be easily updated when the rules that apply to trie 101 change. All that is required is to set the bits in rule vector 403 as now required for the changes in the rules and to update rule array 405 as required for the changes.

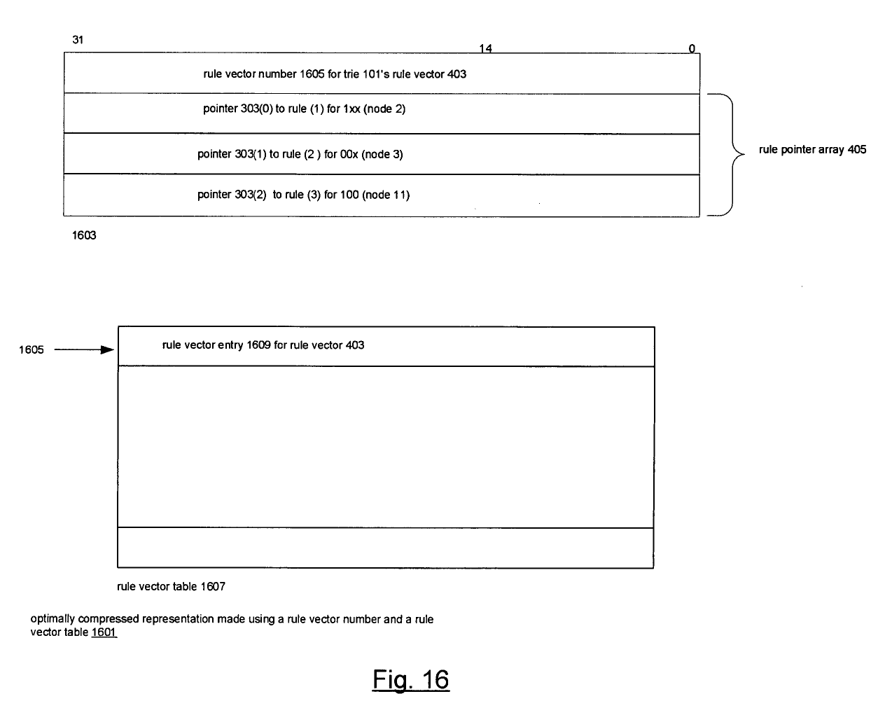

Using rule vector numbers instead of rule vectors in compressed representations: FIG. 16 A problem with rule vectors is that there is a bit in the bit string for every single-stride node in the trie, so that the rule vector quickly becomes larger than the pointers in rule pointer array 405. Since it is generally the case that many of the possible combinations of rules and nodes in the trie will not be used at a given time, one can make a list of the combinations of rules and nodes that are required at a given time and map the structural enumerations for the required combinations to a set of integers. The integer that is mapped to given structural enumeration can then represent the structural enumeration in the compressed representation. This is shown in FIG. 16, where the rule vector has been replaced by rule vector number 1605 and rule vector table 1607 has been added, in which each entry 1609 contains a rule vector, with the entry's index being the rule vector number to which the rule vector has been mapped.

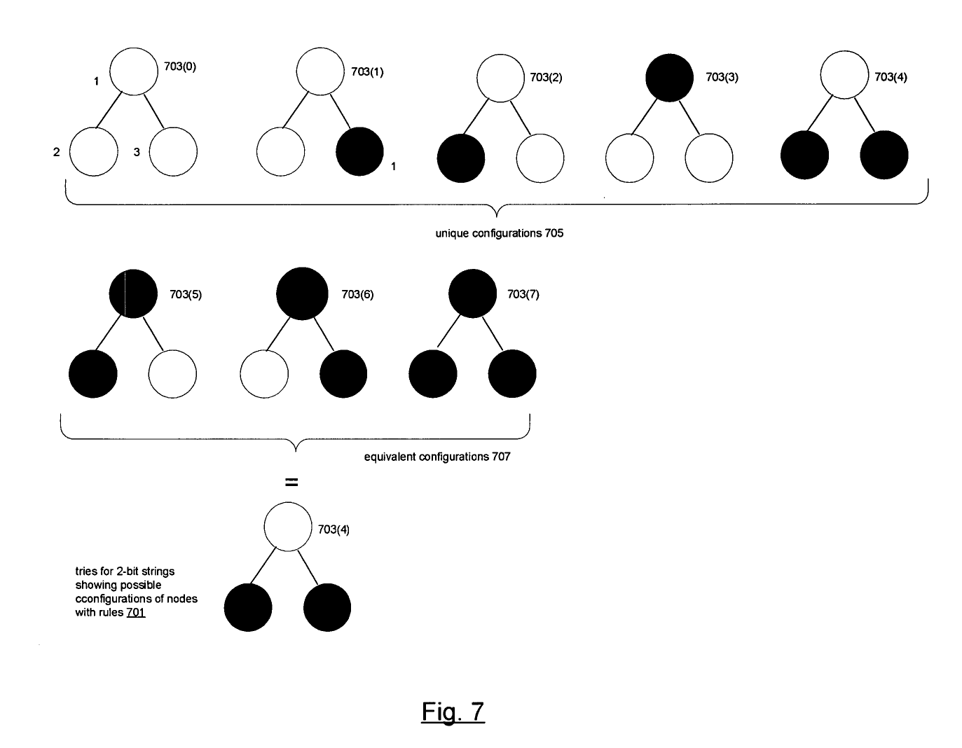

Compressed Representations of Tries Made Using Effective Enumeration: FIGS. 7-10

The compression scheme of FIGS. 4 and 16 is perfect; its only problem is that when the trie becomes large, the number of possible structural enumerations is so large that even rule vector number 1605 becomes too large for the compressed representation. For large tries, therefore, a technique is required which reduces the size of the set of structural enumerations needed for the tries.

Effective Enumerations: FIG. 7

Such a technique is provided by observing that a given perfect trie may have other perfect tries that are equivalent to it. FIG. 7 shows the eight possible configurations of perfect single-stride tries in a trie of stride 2. Each configuration 703 shows a combination of nodes with and/or without rules. Nodes associated with rules are black; nodes that have no rules associated with them are white. As shown at 705, only configurations 703(0 . . . 4) are unique. The configurations 703(5 . . . 7) are equivalent to configuration 703(4), in which each of the leaf nodes is associated with a different rule. That is, the effect of all of these configurations on the leaf nodes of the trie is the same as if the configuration were configuration 703(4). Because the configurations are equivalent, configuration 704(4) can render configurations 703(5 . . . 7) redundant.

The reason configurations 703(5 . . . 7) are equivalent to configuration 703(4) is rule inheritance. If the node has a rule associated with it, that is the rule that applies. Otherwise, the rule that applies is the rule associated with the nearest ancestor of the node. This rule is termed an inherited rule. Thus, in the case of configuration 703(7), the rules that apply are the rules associated with the leaf nodes, the rule associated with the root node is irrelevant, and 703(7) is equivalent to 703(4), in which the root node has no rule. In the case of configuration 703(5) and (6), the leaf node which presently has no rule inherits the rule of the root node. If the rule associated with the root node is promoted to its descendant, what results is again configuration 703(4).

The configurations of FIG. 7 can of course be expressed as structural enumerations. The complete set of structural enumerations is {0 00; 0 01; 0 10; 1 00; 0 11; 1 10; 1 01; 1 11}; three of these structural enumerations, however, correspond to the redundant configurations 707. The set of structural enumerations that contain only the unique configurations 705 make up the set of effective enumerations corresponding to the set of structural enumerations. The set of effective enumerations for the configurations of FIG. 7 is {0 00; 0 01; 0 10; 1 00; 0 11}. Structural enumerations that belong to a set of effective enumerations will themselves be termed in the following effective enumerations; it is, however, important to understand that a set of effective enumerations is a subset of a set of structural enumerations and that each effective enumeration is a structural enumeration.

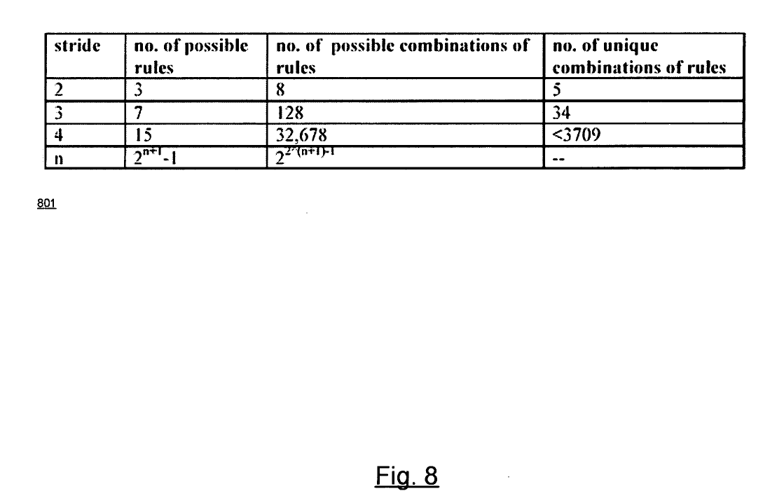

Speaking broadly, because the set of tries of stride 1 includes equivalent tries and structural enumerations can be made using the equivalent tries, it is possible to make sets of structural enumerations that are smaller than but equivalent to the set of structural enumerations for the full set of tries of stride 1 for a node of a trie whose stride is n. These smaller sets of structural enumerations may be perfect or imperfect. The difference between the size of the full set of structural enumerations for a trie of stride n and the size of the equivalent set of effective enumerations increases rapidly as the stride of the trie increases, as shown in table 801 of FIG. 8. The size of the equivalent set of effective enumerations can be reduced as far as desired if imperfect compression is allowed.

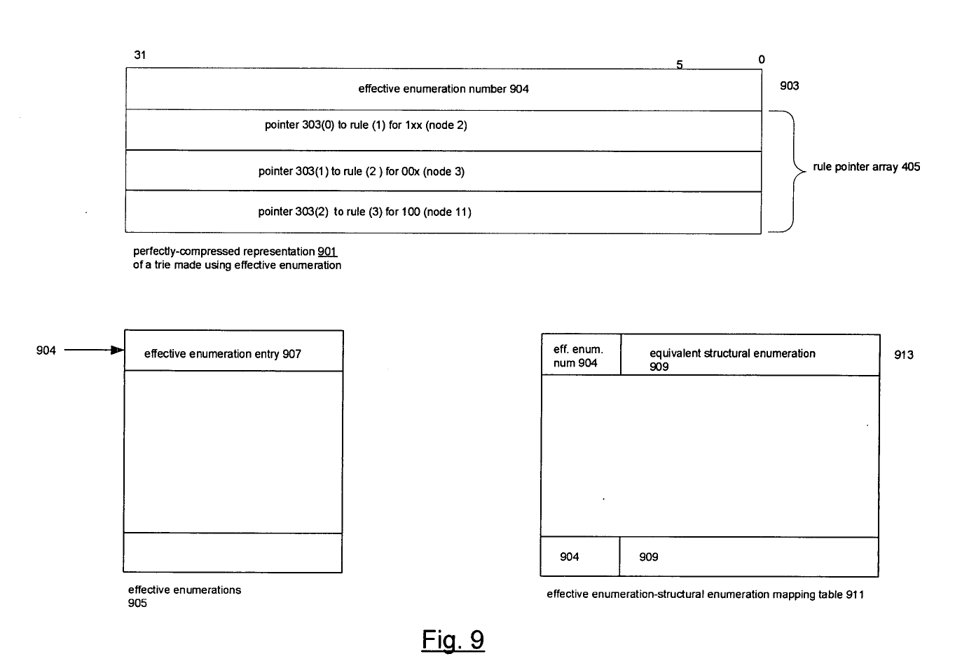

FIG. 9 shows how effective enumerations can be used to make a perfectly-compressed representation 901 of trie 101 of FIG. 1. The compressed representation includes an effective enumeration specifier 903 which contains an effective enumeration number 904. Effective enumeration number 904 specifies the one of the 34 effective enumerations of a trie with a stride of three which applies to trie 101. Since only 34 enumerations need be specified, only 6 bits are needed for the effective enumeration number 904. Effective enumeration-structural enumeration mapping table 911 is used to encode a structural enumeration as the effective enumeration number for the effective enumeration that is equivalent to the structural enumeration. Each entry 915 of the table contains a structural enumeration 909 and the number of the equivalent effective enumeration. Effective enumeration table 905 is used to decode effective enumeration numbers into bit vectors representing the effective enumerations. There is an entry in table 905 for each effective enumeration and the entry is indexed by the effective enumeration number 904.

When compressed representation 901 is made, the structural enumeration for the node is computed and applied to table 911 to determine the effective enumeration number of the effective enumeration which is equivalent to the structural enumeration. That number is written into field 903 of the compression. When compressed representation 901 is read, effective enumeration number 904 is used with table 905 to obtain the effective enumeration and the effective enumeration is used in exactly the same fashion as the structural enumeration it is equivalent to to determine which of the three rules in trie 101 apply to the node corresponding to the key being applied to the trie. There is of course only a single table 905 and a single table 911 for all tries of stride three.

In broad terms, compressed representations like those shown at 901 include a structural enumeration representing the node and a rule access list (embodied here as array 405). Symbols in the structural enumeration are set to a first setting if they represent rules associated with the node. The rule access list has an entry for each of the rules associated with the node. The entry contains information which permits access to the entry's rule. The order of the entries in the rule access list corresponds to the order of the set symbols for the rules in the structural enumeration. The trie of stride 1 from which the structural enumeration is made may have only one node associated with a given rule or it may have more than one node associated with a given rule. In the latter case, the compression of the compressed representation is imperfect. The structural enumerations used to represent nodes of stride n may belong to a set of structural enumerations which is smaller than the set of tries of stride 1 corresponding to possible nodes of stride n. The compressed representation may further include a specifier that specifies a structural enumeration in the set of structural enumerations.

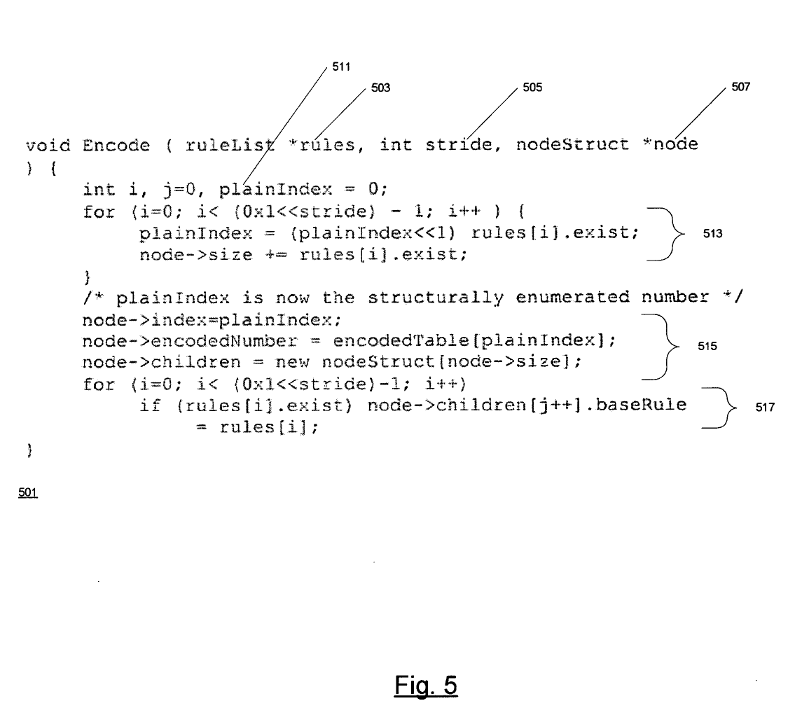

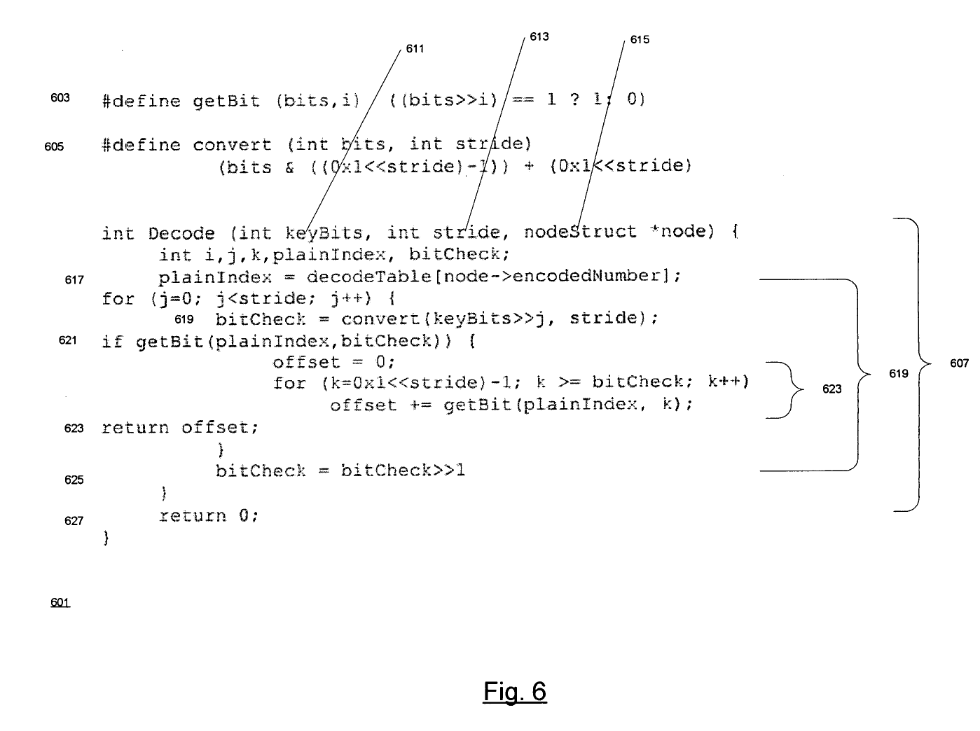

Details of Making and Reading Perfectly-Compressed Representation 901. FIGS. 5 and 6

Making a Perfectly-Compressed Representation 901: FIG. 5

FIG. 5 shows example code 501 for making a perfectly-compressed representation for a node A having a given stride. The arguments are:
a pointer to a list of the nodes of stride 1 in node A; there is an entry in the list for each of the nodes of stride 1 in node A and the entry contains a value which indicates whether there is a rule associated with the stride 1 node and if so, a pointer to the rule.
the stride of node A.
a pointer to a data structure that represents node A. The data structure includes a value for the size of node A, a value for the node's structural enumeration 404, a value for its effective enumeration number 904, and a pointer to a child node that contains rule pointer array 405.

The code has three parts: in loop 513, the code works through the list of rules to make a bit string that is a structural enumeration 404 of the nodes of stride 1 in node A and computes the size of the node data structure needed to accommodate the necessary rule pointers. The structural enumeration is made in the variable plainIndex, which is initialized to “0” bits. On each iteration of the loop, the variable is shifted left one bit and the new lsb is set to “1” if there is a rule associated with the current node and otherwise to “0”. Similarly, the size of the node data structure for the rule pointers is incremented by 1 each time there is a rule associated with the current node.

At 515, a table called encodedTable (table 911 in FIG. 9) is used to find the effective enumeration number encodedNumber which specifies an effective enumeration that is equivalent to the structural enumeration in plainIndex and the child node for the array of pointers is made using the size computed in loop 513. In loop 517, the code again works through the list of rules. If there is a rule for a node, a pointer to the rule is added to the array of rule pointers in the child node. Once code 501 has been used to compute the structural enumeration, find the equivalent effective enumeration, and make an array of the rule pointers, a data structure for the information is made that contains effective enumeration specifier 903 and a pointer to a location in memory that contains the array of child nodes.

Reading Perfectly Compressed Representation 901: FIG. 6

FIG. 6 shows the code 601 used in a preferred embodiment to decode representation 901, i.e., to find what rule applies to a given key. Decode function 607 takes three arguments: bits of a key 611, stride 613, and a pointer to a compressed representation 401 at 615, and returns the offset in rule pointer array 405 of the rule (if any) that corresponds to the key. The function further uses two other functions: getBit 603, which takes a bit string and an integer as arguments and returns the value of the bit of the string at the position specified by the integer, and convert 605, which converts the bits of the key into a value which can be compared to the effective enumeration for the node in plainIndex.

Suppose we have a 32-bit key 0x8004021b and that the trie used with the key has nodes with a stride of 4. We have already resolved the most significant 24 bits of the key and now we are working on bits 4-7, which have the value 0001. The arguments for Decode 107 are thus 0001, 4, and a pointer to the node with the stride of 4 for this part of the key. The field encodedNumber of this node contains the effective enumeration number for the node, which is 102.

The first thing Decode does, at 617, is to get effective enumeration number 904 for the node and use table 905 to convert it to the effective enumeration for the node. The effective enumeration is stored in plainIndex. For purposes of this example, the effective enumeration is 0 00 0100 11001111, which is equivalent to the original structural enumeration 0 10 101101001001.

We then find the bit in the effective enumeration for the rule, if any, that applies to our key. To do that, we start by looking at the bits in the effective enumeration that correspond to the bottom row of the trie of single-stride nodes that is equivalent to our node of stride 4 and work up the effective enumeration until we find the set bit of the effective enumeration which corresponds to the rule that applies to our key. The position of the set bit in the effective enumeration gives the offset of the rule that applies to the key in rule pointer array 405. The portion of Decode 607 that does this is loop 619.

On each execution of loop 619, the first step is to use convert 603 to convert our key bits into the number of a node in the single-stride trie representing the node of stride 4, so that we can see whether the bit of the effective enumeration corresponding to the node specified by the node number is set. The conversion is based on the stride of the node. Here, the key bits are 0001. convert 603 converts 0001 into the node number 9, which is stored in bitCheck. Counting from the left, the ninth bit of the effective enumeration is 1. Because the bit is set, we need to determine which rule is associated with the ninth bit. So we count how many bits prior to the ninth are set in the effective enumeration. Again counting from the left, the ninth bit is the third rule so offset is set to 3. We then return this for use in locating the rule for the key in rule pointer array 405.

If our ninth bit weren't set, we'd need to check whether the ninth node of the single stride trie inherited any rules from nodes higher up in the trie. In the example, there are none, but to find this out, we need to go up the single stride trie from node 8 to node 0. The path to do this goes via nodes 3, 1, and 0, so Decode must check the fourth, second, and first bits (counting from the left) in the effective enumeration This is done in loop 607. If nothing is found, an offset of 0 is returned.

Note that loop 619 doesn't need to be implemented as a loop. All of the operations are single bit compares and shifts. Consequently, hardware can be designed that will do the decode as a single operation. Such hardware could:
Read in 64 bits of data in cycle 1.
Compute the offset in decode(memory data) in cycle 2.
go fetch the next 64 bits of data cycle 3.
Etc.

General Method for Finding Effective Enumerations

Terminology

The following description of a general method for finding effective enumerations uses the following terminology, shown using FIG. 7:

node numbering: Nodes are numbered starting with 1 at the base, as shown at 703(0) in FIG. 7. A node with bit a always has children numbered 2a, 2a+1, and grandchildren 4a, 4a+1, 4a+2, 4a+3. Thus bit 1 has children 2,3. Child bit 2 has children 4,5 and grandchildren 8,9,10,11.

covered nodes: a node that has a rule is covered if rules belonging to the node's descendants keep any of the node's descendant leaf nodes from inheriting the node's rule; it is partially covered if some of the descendant leaf nodes do inherit the node's rule. Thus, the root node of configuration 703(7) is covered and the root nodes of configurations 703(5) and (6) are partially covered. The covering of a node by rules belonging to the node's descendants permits the covered node's rule to be removed from the effective enumeration; the partial covering of a node by rules belonging to the descendent nodes allow the rule belonging to the node to be removed from that node and “promoted” to a descendant node. Thus, in configuration 703(5), the rule belonging to the root node is promoted to the right-hand child 3 and in configuration 703(6), the rule belonging to the root node is promoted to the left-hand child node 2.

### COVERING EXAMPLES

In the following examples, again based on FIG. 7, single-stride tries are represented by rule patterns. Thus, configuration 703(0) is represented by the rule pattern 0 00 and configuration 703(1) is represented by the rule pattern 0 01.

### EXAMPLES

a) 1 01→partial covered→promote bit 1 to position 2, 1 01 is best expressed as 0 11.

b) 1 10→partial covered→promote bit 1 to position 3, 1 01 is best expressed as 0 11.

c) 1 11→fully covered→bit 1 never expressed, 1 11 is best expressed as 0 11.

d) 1 00 1110→bit 1 is not covered by 2,3 but is covered by grand children 4,5,6, so promote rule at bit 1 to position 7, express 1 00 1110 as 0 00 1111.

Complex covering cases do arise: 1 10 0011 is such a case. In this case bit 1 is fully covered by bit 2 and by bits 6 and seven. In this case, the equivalent 0 10 0011 has one fewer rule to be stored. This and other such cases are detected by determining whether a node is fully or partially covered by another node When this is the case, the node is redundant to the effective enumeration.

Computations Used to Determine Effective Enumerations

Determining Whether a Node is Covered or Partially Covered

The following equation determines whether a node's descendants cover or partially cover the node:

$${C}_{j} ( a ) = {\sum }_{i = 0}^{{2}^{j} - 1} {a}_{{2}^{j} + i}$$

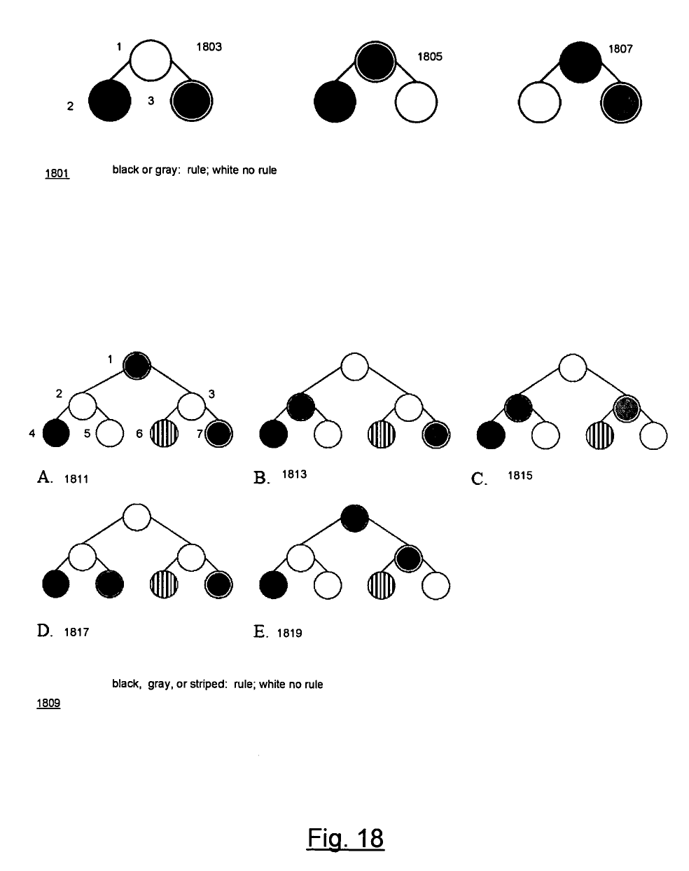

Cⱼ(a) is the count of descendant nodes a of a given node at level j relative to the given node that have a rule associated with them and consequently have a value of 1 in the rule pattern. When Cⱼ(a)=2^{j}, each of the nodes at level j has the value 1, node a is covered by the nodes of level j, and node a is redundant. When Cⱼ(a)=2^{j}−1, there is one node in the row which does not cover node a. When this is the case, node a can be promoted to the row, rendering the unpromoted node a redundant. This is shown at 1801 in FIG. 18. Three possibilities are shown for the stride 1 trie corresponding to a stride 2 node. In possibility 1803, the children of the parent node both have rules, so the parent node is completely covered and is therefore redundant, whether or not there is a rule associated with it. In possibility 1805, the parent has a rule and the right-hand child does not, so the parent's rule can be promoted to the right hand child. In possibility 1807, the parent has a rule and the left-hand child does not, so the parent's rule can be promoted to the left-hand child. The result of the rule promotion in both possibility 1805 and possibility 1807 is possibility 1803, which is thus equivalent to the other possibilities. When the above formula is applied to possibility 1803, in which j=1 and nodes 2 and 3 each have rules and therefore each have the value 1, the result is:

$${C}_{1} ( a ) = {\sum }_{i = 0}^{{2}^{1} - 1} {a}_{{2}^{1} + i} = 1 + 1 = {2}^{1}$$

When it is applied to possibility 1805, in which node 2 has a rule and therefore has the value 1, while node 3 does not have a rule and therefore has the value 0, the result is:
1+0=2¹−1.

Determining Whether a Given Node is Redundant

A given node is redundant to the effective enumeration if it is either fully or partially covered by its descendants. Redundancy of a node is determined by the following equation,

$$R ( a ) = \{ \begin{matrix}1 \text{:} {\sum }_{i = 0}^{{2}^{j} - 1} ( {a}_{{2}^{j} + i} \vert R ( {a}_{{2}^{j} + i} ) ) = {2}^{j} \text{:} completely covered \\ \frac{{2}^{j} - 1}{{2}^{j}} \text{:} {2}^{j} > {\sum }_{i = 0}^{{2}^{j} - 1} ( {a}_{{2}^{j} + i} \vert R ( {a}_{{2}^{j} + i} ) ) > {2}^{j} - 1 \text{:} patially covered \\ 0 \text{:} {\sum }_{i = 0}^{{2}^{j} - 1} ( {a}_{{2}^{j} + i} \vert R ( {a}_{{2}^{j} + i} ) ) < {2}^{j} - 1 \text{:} neither\end{matrix}$$

where j ranges from 0 to the stride size n.

A graphical example of redundancy is shown at 1809 in FIG. 8. Tries 1811-1819 are all equivalent with regard to the rules they contain; consequently, any one of the tries can replace all of the other tries, which are then redundant with regard to the trie that replaces them. When the above equation is applied to node 2 of trie 1811, which has the structural enumeration 1 00 1011, the redundancy R(aₓ) of node 2 is found with regard to the next level of nodes, so j=1.

$$R ( {a}_{2} ) = \{ \begin{matrix}1 \text{:} {a}_{4} + {a}_{5} = {2}^{j} \text{:} false \\ \frac{{2}^{j} - 1}{{2}^{j}} \text{:} {2}^{j} > {a}_{4} + {a}_{5} > {2}^{j} - 1 \text{:} True \\ 0 \text{:} {a}_{4} + {a}_{5} < {2}^{j} - 1 \text{:} false\end{matrix}$$

Thus R(a₂)=(2^{j}−1)/2^{j}=½, which is correct, since node a₂ has no rule associated with it and therefore cannot be promoted.

The results of the above equation can be used to process the node of the trie of stride 1 that the equation is applied to or the node's parent nodes. If R(a₂) had been 1, we would have known that a₂ was partially covered and could have been promoted to the open space below. Continuing up the trie to process a₂'s parent (node a₁), we can calculate R(a₁) to see if it is completely covered, or partially covered or neither. R(a₁) is based on the sum of either a₂ or R(a₂) and either a₃ or R(a₃). Because both a₂ and a₃ are zero, R(a₂) and R(a₃) are used and R(a₁)=1.5. This means bit a₁ is partially covered. This form of combination algebra allows us to convert a trie of stride 1 with a given combination of nodes with rules and nodes without rules into an equivalent trie of stride 1. The transformations are many to one, and deterministic such that the resulting set of tries of stride 1 are all unique and therefore represent effective enumerations.

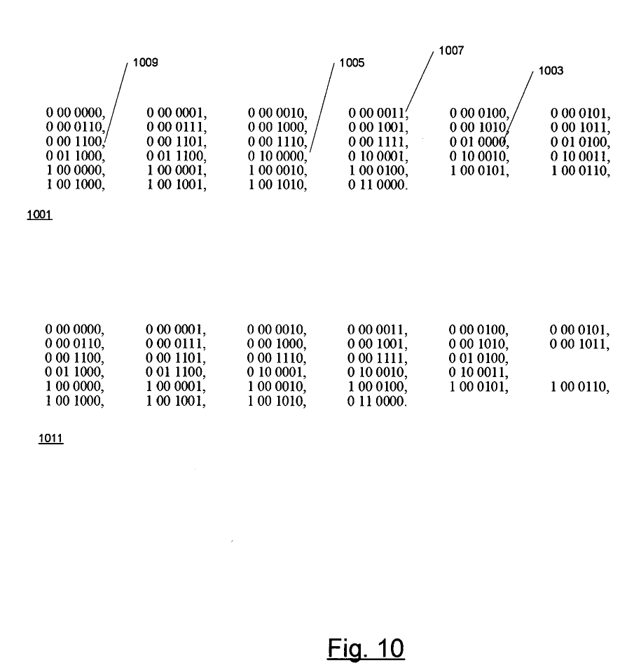

Reducing the Number of Effective Enumerations Required: FIG. 10

Even with effective enumerations, as the stride of a trie becomes longer, the set of its possible effective enumerations soon becomes so large that the effective enumeration number becomes too long. A solution to this problem is imperfect compression. As already set forth, imperfect compression results when a compressed representation is made using a structural enumeration of an imperfect trie of stride 1. The degree of imperfection of an imperfect trie is measured by the difference between the number of nodes with rules that the imperfect trie has and the number of nodes with rules that an equivalent perfect trie has. The difference is also the number of extra pointers to rules that the imperfectly compressed representation has. The advantage of imperfect compression is that it permits reduction of the size of the set of structural enumerations by mapping a perfect structural enumeration onto an equivalent unused imperfect structural enumeration and discarding the perfect structural enumeration. For example, in the rule pattern 0 01 0000, the rule in node 3 is inherited by nodes 6 and 7, so the pattern 0 00 0011 is equivalent to 0 01 0000, but there are now two nodes with which the rule of node 3 is associated, instead of one, so there will be an extra rule pointer in the pointer array. Of course, imperfect structural enumerations may be mapped onto even less perfect structural enumerations in the same fashion.

One situation in which imperfect compression can be done is with structural enumerations whose corresponding tries have nodes whose rules would be inherited by the nodes' descendants. If the rule associated with such a node in a given such trie is promoted to the descendents who would inherit it, the result is a less-perfect trie, and similarly, the structural enumeration for the less-perfect trie is less perfect than the structural enumeration for the original trie. An example of this is the following: with tries of stride 3, there are 34 perfect effective enumerations; the effective enumeration numbers must consequently have at least 6 bits. If the number of effective enumerations can be reduced to 32, only 5 bits would be required for the effective enumeration number. FIG. 10 shows how this can be done. The 34 perfect effective enumerations for stride 3 nodes are shown at 1001. Effective enumeration 1005 and effective enumeration 1003 both have a node in the second level with a rule that will be inherited by nodes in the third level. Consequently, these effective enumerations can be expressed by promoting the rule from the second level node to the third level node that inherits it. Effective enumeration 1003, 0 01 0000, is thus equivalent to 0 00 0011 and effective enumeration 1005, 0 10 000, is equivalent to 0 00 1100. 0 00 0011 is, however, perfect effective enumeration 1007 and 0 00 1100 is perfect effective enumeration 1009. Consequently, effective enumerations 1005 and 1003 can be removed from set of effective enumerations 1001 to produce set of effective enumerations 1011, which includes both perfect and imperfect effective enumerations. The cost of imperfect compression is of course the extra space required for the duplicate rule pointers in the rule pointer array.

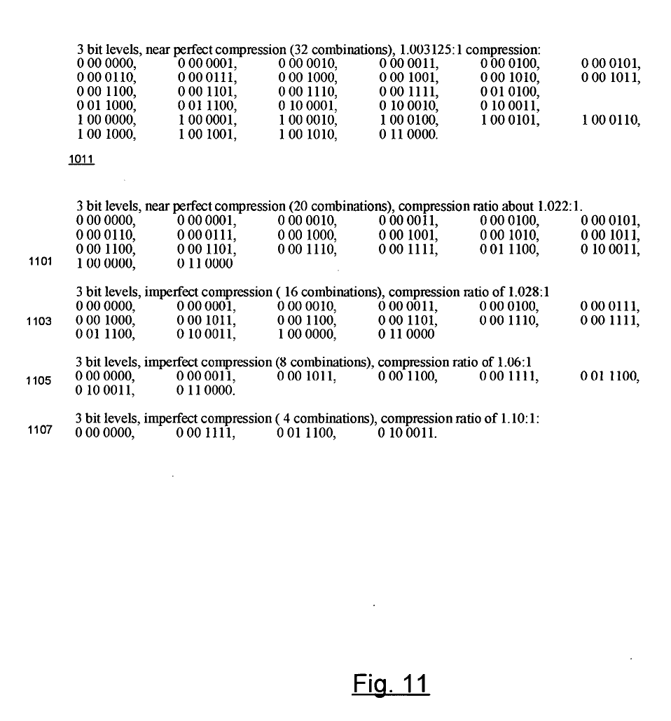

Of course, the process shown in FIG. 10 may be repeated to further reduce the number of effective enumerations However, as indicated above, a result of the compression process is that more pointers to rules are required in imperfect compression than in perfect compression, and as the number of effective enumerations is reduced, more such pointers to rules are required. The ratio between the total storage required for all possible compressed representations made using a reduced set of effective enumerations that includes imperfect effective enumerations and the total storage required for all of the compressed representations made using the complete set of perfect effective enumerations is termed in the following the compression ratio for the reduced set. FIG. 11 shows how the set of effective enumerations for a trie of stride three may be further reduced and how these reductions affect the compression ratio. The effective enumerations shown at 1011 are the result of the mapping shown in FIG. 10; the effective enumerations shown at 1101-1107 are the result of further mappings.

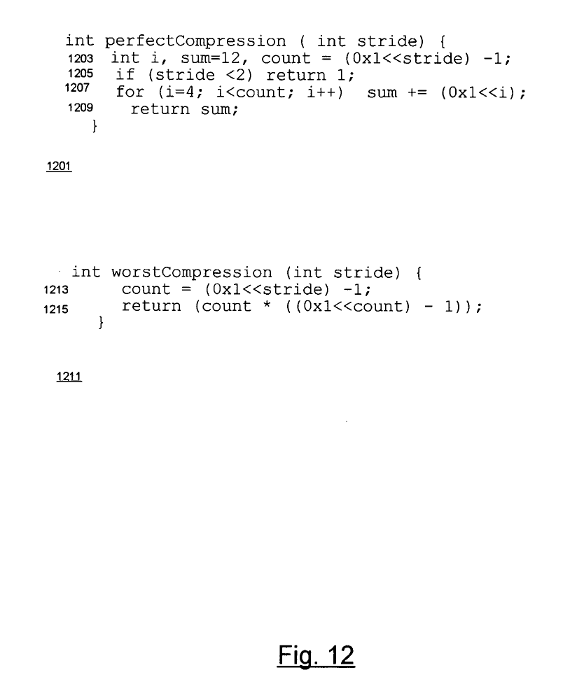

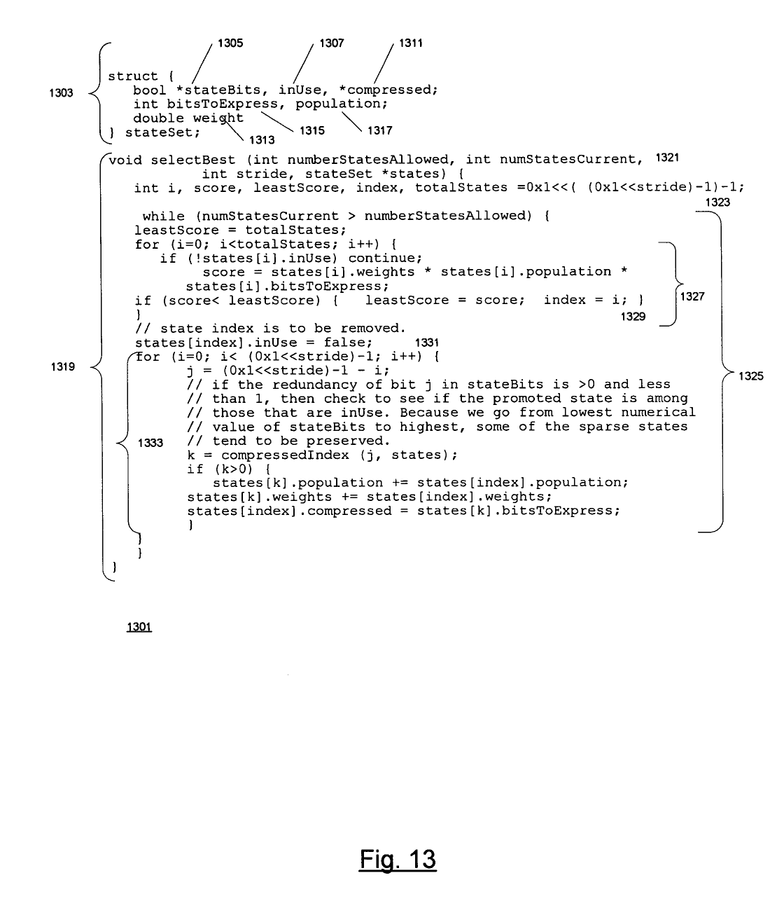

Determining Which Effective Enumerations to Remove in Imperfect Compression: FIGS. 12 and 13

As just demonstrated, many different equivalent sets of imperfect effective enumerations may be made from a given set of perfect effective enumerations. Any imperfect compressed representation made using an imperfect effective enumeration differs from the perfect compressed representation made from an equivalent perfect effective enumeration differs from its perfect counterpart in the greater number of rule pointers required for the imperfect compression, and the extra rule pointers in turn increase the amount of space required for the representation of the imperfect compression and the number of memory references required to reach a rule. The choice of an imperfect compression has an impact not only based on how well that alphabet of tries is at keeping extra pointers to a minimum. This size of the alphabet itself impacts the amount of memory of each node. If one alphabet uses only 8 bits and another uses 16, the second scheme uses twice as much memory per node. Unless it greatly increases the stride depth or does a much better job of keeping the extra pointers indexed by a node to a minimum, it might not be worth the extra bits. The effect on performance of the number of memory references is of course a function of the frequency with which the rule concerned must be reached. Thus, selecting a best imperfect compression of a set of effective enumerations means removing effective enumerations with an eye to the effect of the removal on both the number of extra rule pointers and the frequency with which the rule pointed to by an extra rule pointer must be reached.

In the following discussion, enumerations of the nodes of a trie that have rules and those that do not have rules are termed states; when considered as a structured enumeration, a state is termed a structured state; when considered as a member of a set of effective enumerations, the state is termed an effective state. The best way of selecting a set of effective states is to first list the structural states, and then count how many structural states map to each effective state. To select an effective state to remove, the population of structural states that will be imperfectly compressed must be accounted for, and the effective compression must be measured. If all possible states are equally likely, the best metric is the number of rules in the rule array if every state is used.

FIG. 12 shows a function perfectCompression 1201 that takes a trie's stride and determines the total number of rules used in every one of the effective states in the perfect compression and thus the total number of rule pointers. The number of possible effective states and of rules is of course determined by the size of the single-stride trie corresponding to the given trie, and that is determined by the given trie's stride. For example, where stride=3, count at 1203=binary 3 shifted 1 to the left, which equals binary 6 and count=5. Since stride=3, the branch at line 1205 is not taken. Further, since count=5, loop 1207 is executed once with i=4, binary 4 shifted 1=8, and count=20, which is the total number of rules that may be used in the complete set of perfect effective enumerations for a trie of stride 3. FIG. 12 also shows a function worstCompression 1211 that takes a trie's stride and returns the total number of rule pointers that may be used in the complete set of perfect and imperfect structural states. Where stride=3, 3 shifted 1 bit to the left=6, and count=6−1=5 in line 1213. In line 15, the returned value is 5 shifted 1 bit to the left=12, 12−1=11, and 5*11=55, which is the maximum number of rules the complete set of perfect and imperfect structural enumerations for a trie of stride 3. Thus, the number of rules required for a set of perfect and imperfect structural enumerations for a stride 3 trie may range between 21 and 54 rules.

One can determine the number of rules in a state from the state's structural enumeration, and thus the number of rule pointers required for a compressed representation of the state. The number of rule pointers required for a state is termed the state's order. The following equation determines the order of the state c, or O(c):

$$O ( c ) = {\sum }_{i = 1}^{{2}^{n}} {a}_{i}$$

This equation can be used to select among imperfect compressions. If there are two states N, and N₂ such that N₁ is equivalent to N₂, O(N₁) can be compared with the O(N₂) to determine which of the states has the lower order and thus the lower cost in storage space. This determination can further be weighted by how often an effective state is reached, since the cost of extra memory references is more important with frequently referenced states than with infrequently referenced states.

A Function to Reduce the Number of States Required to Represent a Trie: FIG. 13

A method of reducing the size of a set of structural enumerations of tries belonging to a set of tries of stride 1 where the tries in the set correspond to possible nodes of a trie of stride n>1. method includes the steps of selecting a candidate structural enumeration in the set of structural enumerations; determining whether there is a trie of stride 1 that is equivalent to the trie of stride 1 that corresponds to the candidate structural enumeration; if there is, determining whether there is an equivalent structural enumeration in the set that corresponds to the equivalent trie of stride 1; and if there is, removing the candidate structural enumeration from the set. The method steps may be repeated until the set of structural enumerations reaches a predetermined size. A candidate structural enumeration may be selected according to the likelihood that the candidate will be needed to decode a key or according to the number of equivalent structural enumerations that have already been removed from the set. So, if one has candidates A, B, C, D and A is likely to be used 5% of the time, B 3%, C 4%, and D 1%. From the likelihoods of use, A and C are the best candidates for retention. But if D renders A and D redundant at the cost of one extra rule pointer, then D is a better candidate for retention than A or B.

Code 1301 of FIG. 13 methodically and optimally implements the a above method. Code 1301 includes a data type, stateSet, and a function, selectBest 1319. The function reduces the size of the set of states required to represent all of the possible enumerated states for a node of a trie of stride n until the set of states reaches a size that is included as the parameter numberStatesAllowed. In overview, code 1301 works like this: continuing until the number of effective states reaches numberStatesAllowed (loop 1325), it takes a candidate structural state belonging to the set of effective states and if the candidate has not already been discarded, computes a score for the state that indicates the state's value in the set of effective states (loop 1327). The state with the lowest score calculated by loop 1327 is chosen for removal from the set of effective states. In loop 1333, states that the make the state with the lowest score redundant are found and the scores of those states are increased. Then loop 1325 iterates again.

Continuing in more detail, the set of effective states for the node of stride n whose size is being reduced is represented in an array states whose elements are structures of the type stateSet, shown at 1303. Each element represents a single structural state. Fields in stateSet include fields representing the structural state and its effective equivalent and fields indicating how the effective state is to be scored during the compression process. The fields representing the structural state and its equivalent effective state are, *Statebits 1305, which is the bit string representing the structural state, *compressed 1307, which is a bit string that has a bit for each of the states and sets bits to indicate the effective state or states that render the state redundant, and inUse 1307, which indicates whether the structural state has been removed from the set of effective states. The fields used to score the structural state are bitsToExpress, which has a bit set for each of the effective states that is currently in use, population, which indicates the number of structural states that the effective state renders redundant, and weight 1313, which is the normalized likelihood that the effective state will be required to decode a key. Also required, but not shown, is a table that relates each vector for a structural state in states to the index number of the element in states that contains the vector for that structural state.

At 1321, selectBest takes as arguments numberStatesAllowed, which is the number of structural states that is permitted to be in the set of effective states used in the imperfect compression, numStatesCurrent, which is the current number of structural states in the imperfect compression, stride, which is the stride of the trie, and *states, which is a pointer to an array of the structures stateSet 1303, with an element for each structural state of the trie. Local variables of interest at 1323 include score, which holds the score for the structural state currently being processed, leastScore, which holds the lowest score yet found for a structural state, and totalStates, which is the total number of enumerated states as computed from stride.

The body of selectBest is while loop 1325. At the top of the loop, leastScore is set to the total number of structural states. In for loop 1327, each element of states is examined in turn; if the element is in use, as indicated by inUse 1307, the element's score is computed as the product of the values of its weights, population, and bitsToExpress fields. If the computed score for the element currently being examined is lower than the previous lowest score, leastScore is set to score and the value of the variable index is set to the index of the element currently being examined (1329). Thus, when loop 1327 is finished, index is set to the index of the element with the lowest score. The effective state represented by this element is of course the best candidate for being removed from the set of effective states. To indicate that the element's effective state has been examined for removal, the element's inUse flag is set to false.

Whether the state that is the candidate for removal can be removed from the imperfect compression's set of structural states is determined by whether the candidate state can be made equivalent to another structural state by promoting a rule in the candidate state to a descendant of the node associated with the rule. This determination is made in for loop 1333, which checks the bits in stateBits 1305 in the candidate structural state to determine whether any bit in the bit string representing the structural state is redundant in that the bit represents a node in the trie of stride 1 whose rule need not be expressed at all in the trie of stride 1 or can be expressed in a descendant of the node in the trie of stride 1 that the rule is currently associated with. If a redundant bit is found, the candidate structural state can be made into an equivalent structural state by removing the node's rule from the node or promoting the rule to a descendant node. A version of the element's stateBits bit string is made which reflects the promotion and the bit string is used to locate the element of *states which has that bit string That element represents the structural state that is equivalent to the state that is the candidate for removal. If such an element is found, its scores are updated with the scores from the candidate element and the candidate element's compressed field is updated to the value of the equivalent state's bitsToExpress field. As can be seen from the foregoing, the process of removing candidate states continues in while loop 1325 until the number of effective states remaining is that specified in numberStatesAllowed.

The value of weight in each element takes into account the effective state's order and the cost of that order in terms of the probability that the effective state will be required to find the rule for a key. Thus, the value of the weight of a given effective state can be expressed as follows:

The order of a single state sⱼ:

$$O ( {s}_{j} ) = {\sum }_{i = 1}^{{2}^{n}} {a}_{j , i}$$

The probability that the state si will be needed to find the rule for a key:

$$C ( {s}_{j} ) = {w}_{j} {\sum }_{i = 1}^{{2}^{n}} {a}_{j , i}$$

The total cost of a set S of states s:

$$T ( S ) = {\sum }_{j = 0}^{number States} C ( {s}_{j} ) = {\sum }_{j = 0}^{number States} {w}_{j} {\sum }_{i = 1}^{{2}^{n}} {a}_{j , i}$$

The optimal imperfect compression is of course the imperfect compression that has the lowest total cost of the imperfect compressions which have the desired number of effective states.

Another way of finding the optimal imperfect compression is using a genetic approach such as the Paris method to generate possible effective states which have “low” increases to the compression ratio. In such an approach, during the while loop, a variety of possible states to eliminate are generated. and from them a generation of states arrays are copied, each differing by which state was removed. On the second pass more states would be generated by repeating the process, creating a new set of variants from each of the first set of variants. Those that are outside a margin from the leastScore of the best candidate from the current generation are dropped (a maximum number of state sets can also be used to remove sets to reduce computational complexity). When finally the numStatesCurrent equals numberStatesAllowed, the set of states with the best compression ratio is used.

Compressed Representations of Effective Enumerations of Large Tries

A problem with using the techniques just described for compressing effective enumerations of tries with strides larger than 4 is that for such effective enumerations, it is not presently practical to construct dedicated hardware for converting the effective enumeration specifier 903 for a particular effective enumeration of the trie to the bit string representing that effective enumeration. This problem can be solved by subdividing the large trie into subtries of the maximum stride, that is, the maximum stride for which dedicated hardware can be constructed, and then making compressed representations of the effective enumerations of those subtries. Where the keys being provided to the trie have known characteristics, the subdivision of the large trie can take advantage of these characteristics.

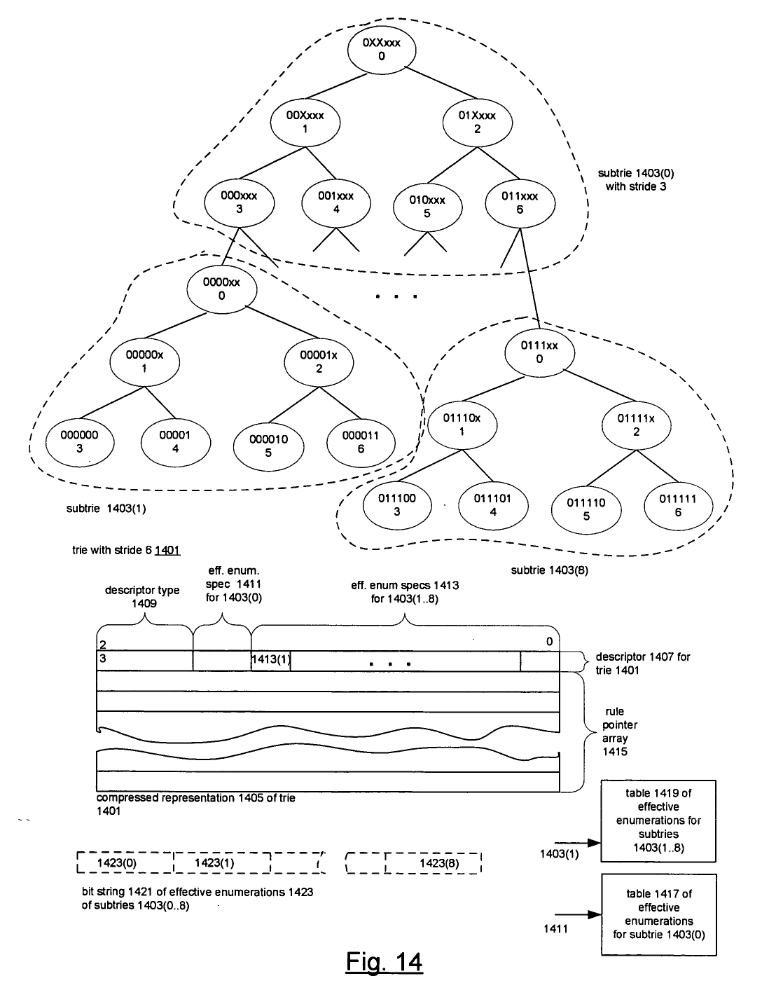

Simple Aggregation: FIG. 14

The most general technique for dividing a trie into subtries is simple aggregation. The trie is simply partitioned into a number of layers, each of which is made up of subtries of the maximum stride or smaller. Suppose a node of stride six is required. This can be thought of as one sub-node of stride three, and eight children sub nodes of stride three. The table that would convert 3 bit levels into an encoded value has 34 entries, so perfect compression would require 34⁹=60716992766464<2⁴⁵ effective enumerations to be encoded. If each of the 9 sub nodes of stride 3 were compressed using 7 effective enumerations, then the effective enumeration specifier would require only three bits; if the compression were done using 15 effective enumerations, the effective enumeration specifier would require 4 bits.

A method of making a representation in the memory of a computer system of a node of a trie of stride n>m where there may be rules associated with the node and m may be the maximum stride for which structural enumerations are efficiently manipulatable by the computer system. The method includes the steps of subdividing the trie of stride n into subtries having strides≦m; for each of the subtries with which rules are associated, obtaining a structural enumeration specifier for a structural enumeration for the subtrie that belongs to a set of structural enumerations for subtries having that subtrie's stride; and for each of the subtries, using the structural enumeration identified by the structural enumeration specifier to make a representation of the subtrie that includes the subtrie's structural enumeration specifier and an array of specifiers for the subtrie's rules. The order of the rules in the array corresponds to the order of the symbols for the rules in the subtrie's structural enumeration. The structural enumerations for the subtries may be ordered in the representation in the order of the subtries in the node of stride n.

FIG. 14 gives an example. Trie 1401 has a stride of 6. It has been subdivided into 9 subtries 1403(0 . . . 8), each of which has a stride of three. Subtrie 1403(0) deals with bits 0 . . . 2 of the key; subtries 1403(1 . . . 8) deal with bits 3 . . . 5 of the key. Each effective enumeration of trie 1401 can be expressed as effective enumerations of the subtries, and thus trie 1401 may be compressed by using an effective enumeration made up of the effective enumerations of all of the subtries to specify locations in the array of rule pointers. Such a compressed representation is shown at 1405. Compressed representations like the one shown at 1405 may be used, as here, were all of the subtries have the same stride or where subtries have different strides.

Compressed representation 1405 has two main parts: a 24-bit trie descriptor 1407 for trie 1401 and an array 1415 of 24-bit rule pointers to the rules associated with trie 1401. Trie descriptor 1407 contains a descriptor type field which contains a bit pattern specifying the form of trie 1401—in this case that it is a stride 6 trie with two levels of stride 3 subtries. Of course, if the implementation uses only tries of the form of trie 1401, descriptor type field 1409 is unnecessary. The remainder of descriptor 1407 consists of an effective enumeration specifier for each of the subtries. The value of each of the effective enumeration specifiers is an index into an array of possible effective enumeration specifiers for the subtrie. In descriptor 1407, there are two such arrays: table 1417, which contains the possible effective enumerations for subtrie 1403(0), and table 1419, which contains the possible effective enumerations for subtries 1403(1 . . . 8). The size of the effective enumeration specifier for a given subtrie will of course depend on the size of the table of effective enumerations for the subtrie.

The effective enumeration specifiers can be used to construct a bit string 1421 of effective enumerations 1423 of subtries 1403(0 . . . 8) and the rule pointers for the rules in rule pointer array 1415 are arranged in the order of the bits corresponding to the keys for the rules in bit string 1421. Depending on the effective enumerations involved, rule pointer array 1415 may be either imperfectly or perfectly compressed. The bit string may be constructed and retained when compressed representation 1405 is constructed or it may be dynamically reconstructed each time a key is received in trie 1401. In the latter case, only as much of the bit string will be reconstructed as is needed to locate the rule pointer corresponding to the key.

An example of how a key may be used to locate a rule pointer in compressed representation 1405 is the following: Assume that the key has the value 011111. This means that the key's rule pointer corresponds to node 6 of subtrie 1403(8) and that the bit corresponding to that node will be set in bit string 1421. In order to translate the set bit into the offset for the rule pointer in rule pointer array 1415, the algorithm begins by applying the first three bits of the key, 011, to effective enumeration 1423(0) for subtrie 1403(0) in bit string 1421. In effective enumeration 1423(0), the bit corresponding to node 6 is set, indicating that the remaining three bits of the key will be resolved in subtrie 1403(7) if the fourth bit of the key is 0 or in subtrie 1403(8) if the fourth bit is 1, which is the case here. The node in subtrie 1403(8) which corresponds to the second three bits of the key, 111, is node 6, so the bit in effective enumeration 1423(8) that corresponds to node 6 should be set. If it is not, the key is invalid.

The next step is determining the index in rule pointer array 1415 for the rule pointer that corresponds to the key. To do this, it is necessary to count set bits in bit string 1421 for the subtries 1403(1 . . . 8). The count begins with subtrie 1403(1) and continues until the position of the bit corresponding to the node that corresponds to the key has been reached. In this case, since the node that corresponds to the key is node 6 of subtrie 1403(8), set bits must be counted in the effective enumerations for all of subtries 1403(1 . . . 8) In general, it is necessary to generate bit string 1421 only up to the point where it contains the effective enumeration for the subtrie that contains the node corresponding to the key. The number of the set bits is of course the index of the desired rule pointer in rule pointer array 1415.

Other techniques can of course be used to represent multi-layered tries. The advantages of the one just described are the small amount of memory it requires and the simplicity of processing the compressed representation. For example, if trie 1401 resolves 26 keys, then the amount of memory required for compressed representation 1401 is 24 bits (3 bytes) for descriptor 1407 plus three bytes for each of the 26 rule pointers, or 81 bytes in all. By contrast, a flat index of rule pointers would have required 384 bytes. As for the processing, if specialized hardware operations are available, resolving a key takes 1 or at most 2 cycles, and the operation can be pipelined:
1) Get node. R0=GNODE(ADDR)
2) Get offset R1=COFF(R0, Key)
3) Update addr. ADDR=R1+ADDR.
4) if flag thrown in HW, stop else. go to step 1.
   The above operation may be implemented in a RISC processor by extending the processor's instruction set or it may be implemented in custom logic in an FPGA or ASIC.

Because of the processing simplicity, the lookup is fast even when it is done in software. A software algorithm for the operation is as follows:
Extract the first three bits of the key;
get the effective enumeration specifier for subtrie 1403(0) from descriptor 1407;
get the effective enumeration for subtrie 1403(0);
use the effective enumeration to determine which effective enumerations for subtries 1403(1 . . . 8) need to be considered;
Use bitstring 1421 containing the effective enumerations to find the position of the bit corresponding to the key;
count the bits in the effective enumerations for subtries 1403(1 . . . 8) up to the position of the bit corresponding to the key to obtain the index of the rule pointer corresponding to the rule.

When imperfect compression is used to make the compressed representations, compression errors in the compressed representation 1405(0) have an 8× effect on compressed representations 1405(1 . . . 8). The average compression ratio is therefore the average of the compression ratio of the compressed representation 1405(0) of the effective enumeration of subtrie 413(0) with the compression ratios of the compressed representations 1405(1 . . . 8) of the effective enumerations of subtries 403(1 . . . 8). For example, if compressed representation 1405(0) has a compression ratio of 1.028 and four of the compressed representations 1405(1 . . . 8) have a compression ratio of 1.028 and the other four have a compression ration of 1.062, then the average compression ratio is (1+0.028125*8) for the top node, and four nodes at 1.028 and four at 1.062=(1.225+4*1.028+4*1.062)/9=1.06:1 average compression ratio for the entire effective enumeration of trie 1401

Using simple aggregation, one can attain near perfect compression for tries with strides up to 7. Previous solutions of this problem had compression ratios of 2:1 to 4:1 on average, with a worst case of 127:1. The imperfect compression just described has a worst case of 9:1 and an average case of less than 1.14:1. With simple aggregation, the compression ratio increases as the trie's stride increases. At two extremes, when a trie is dense, i.e., has many rules, a simple index of all of the nodes in the trie offers reasonable compression; when the node is sparse, existing methods also work well. The techniques disclosed herein work best where the existing methods work least well, namely in large stride nodes.

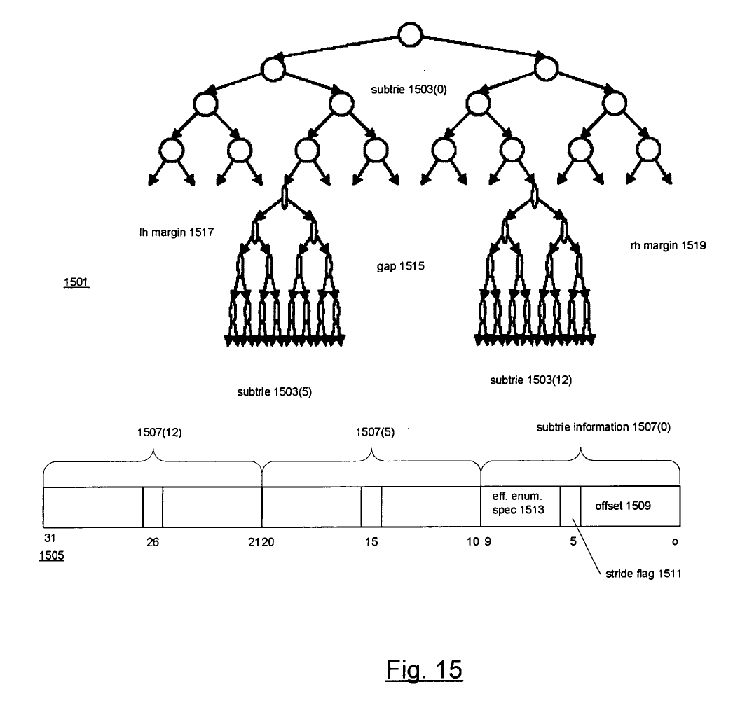

Taking Advantage of the Distribution of Rules Across the Trie: FIG. 15

Often only one or two small areas of nodes within a large-stride trie have any rules associated with the nodes and the remainder of the nodes have at most a default rule. This is especially true of the start of a trie structure for Internet addresses following the IPv6 standard. IPv6 uses the first few bits to divide the table into twelve or so numerical regions. For many large IPv6 tables, the IPv6 table is really several IPv4 tables embedded in the IPv6 table. Thus the first few bits decide on default routings and then, for most routings, a large number of bits are ignored.

FIG. 15 shows how the number of subtries needed to represent such a trie may be reduced. In trie 1501, the only subtries with rules associated with their nodes are the first level subtrie 1503(0) and the two second level subtries 1503(5) and 1503(12). Thus, the only subtries for which compressed representations are of interest are subtries 1503(0,5, and 12). A compressed representation that includes each of these subtries requires the following information: the offset at which the pointers for the subtrie begin in the compressed representation's array of pointers, an indication of the stride of the subtrie (needed to correctly interpret the effective enumeration); and the effective enumeration number for the subtrie's effective enumeration. As shown at 1505 in FIG. 15, all of this subtrie information 1507 for each of the subtries of interest, may be fit into a single 32-bit data word 1505, which together with the array of pointers makes up the compressed representation. The subtrie information for subtrie 1503(0) is at 1507(0); that for subtrie 1503(5) at 1507(5), and that of subtrie 1503(12) at 1507(12).

In general, if a trie has a large stride, but has only pockets of complexity, the trie can be thought of as one or more sub-tries, each having a small stride, that are separated by gaps and margins. Thus, in trie 1501, there is a left-hand margin 1517 between the node at which subtrie 1503(5) attaches and the leftmost node of subtrie 1503(0), a gap 1515 between the node at which subtrie 1503(5) attaches and the node at which subtrie 1503(12) attaches, and a right-hand margin between the node at which subtrie 1503(12) attaches and the rightmost node of subtrie 1503(0).

How the subtrie information is fit into a fixed number of bits depends on the strides of the subtries, the number of subtries, and how much information needs to be stored about the margins and gaps. For example, given a 10 bit stride trie with 2 four bit stride sub-tries within it that processes bits beginning with the seventh bit of the key, offsets of the two subtries' rule pointers each require a six bit number to describe, (or if we limit them somehow say one location per each half of the subtrie, two five bit numbers). Thus the offsets of the subtries consume 12 bits, leaving two 10 bit numbers to describe the effective enumerations. Using the above algorithms to generate a 4 bit stride described ideally in 10 bits results in a compression ratio for those pieces of the effective enumerations of about 1.020 to 1.023.

Conclusion

The foregoing Detailed Description has disclosed to those skilled in the relevant technologies how to make and use structural enumerations of tries and how the size of a set of structural enumerations may be reduced by finding structural enumerations in the set that are equivalent to other structural enumerations in the set and removing the equivalent structural enumerations from the set. The Detailed Description has further disclosed the best mode presently known to the inventor of practicing his invention. It will be immediately apparent to those skilled in the relevant technologies that many embodiments of the invention other than the one disclosed herein are possible. For example, the disclosed embodiment is used to associate routing rules with portions of IP addresses, and representations of nodes of routing tries made using the techniques disclosed herein are particularly well adapted to such applications, with their strict requirements regarding both size of representation and speed of processing. The techniques will, however, work in any application of tries; consequently, the term key is to be understood in the context of the Detailed Description as any string which is being applied to a trie and the term rule is to be understood in that context as being any information which the trie associates with a key.

It should further be noted that mappings between the nodes of a stride 1 trie and the bits of a structural enumeration may differ from the ones disclosed herein and that there are many different ways in which structural enumerations and rule access lists may be implemented and in which a structural enumeration may be associated with a rule access list. There are similarly many different ways in which a node may be divided into subtries and in which the structural enumerations for the subtries may be associated with the rule access lists for the subtries. Finally, when the size of a set of structural enumerations is being reduced, the weightings used to select a structural enumeration to be removed from the set will depend on the application the tries are being used in.

For all of the foregoing reasons, the Detailed Description is to be regarded as being in all respects exemplary and not restrictive, and the breadth of the invention disclosed here in is to be determined not from the Detailed Description, but rather from the claims as interpreted with the full breadth permitted by the patent laws.

What is claimed is:

1. A structural enumeration of a trie of stride 1 wherein one or more nodes of the trie are associated with rules, the structural enumeration being used to represent the trie in memory accessible to a system which processes tries and the structural enumeration comprising:
a string in the memory having a symbol corresponding to each node in the trie, the symbol corresponding to a given node having a first setting if a rule is associated with the given node and a different setting if a rule is not associated with the given node.

2. A representation of a node of a trie, the representation employing the structural enumeration set forth in claim 1, the node having 0 or more rules associated therewith and a stride of n>1, and the representation comprising:
a structural enumeration for a trie of stride 1 corresponding to the node of the trie of stride n.

3. The representation of the node of stride n set forth in claim 2 wherein:
there is a set of tries of stride 1 that correspond to possible nodes of stride n; and
there is a set of structural enumerations in memory, tries in the set of tries of stride 1 being represented in the set of structural enumerations.

4. The representation of the node of stride n set forth in claim 3 wherein:
the set of tries of stride 1 includes equivalent tries; and
the structural enumerations in the set are made using equivalent tries of stride 1 that are selected such that the number of structural enumerations in the set is smaller than the number of tries of stride 1 in the set thereof.

5. A data storage device that is accessible to a processor, the storage device being characterized in that:
the data storage device contains code which, when executed by the processor, produces the structural enumeration set forth in claim 1.

6. A compressed representation of a node of a trie, the node having a stride of n>1, the node having 0 or more rules associated therewith, the compressed representation being used to represent the node in memory accessible to a system which processes nodes of stride n, and the compressed representation comprising:
a structural enumeration for a trie of stride 1 corresponding to the node of stride n, the structural enumeration being a string having a symbol corresponding to each node in the trie of stride 1 and the symbol corresponding to a given node in the trie of stride 1 having a first setting if a rule of the rules is associated with the given node and a different setting if none of the rules is associated with the given node; and
a rule access list whereby the associated rules may be accessed, the list having an entry for accessing each of the associated rules and the entries having an order in the list that corresponds to an order of the symbols having the first setting in the structural enumeration.

7. The compressed representation set forth in claim 6 wherein:
a given rule is associated with only one node in the trie of stride 1.

8. The compressed representation set forth in claim 6 wherein:
a given rule is associated with more than one node in the trie of stride 1.

9. The compressed representation set forth in claim 6 wherein:
the structural enumeration is stored in a set of structural enumerations in the memory; and
the compressed representation includes a specifier which locates the structural enumeration in the set.

10. The compressed representation set forth in claim 9 wherein:
there is a set of tries of stride 1 that correspond to possible nodes of stride n;
there is a set of structural enumerations in memory, tries in the set of tries of stride 1 being represented in the set of structural enumerations; and
the structural enumeration specifier specifies a structural enumeration in the set which represents the trie of stride 1 corresponding to the node of stride n.

11. The compressed representation set forth in claim 10 wherein;
the set of tries of stride 1 includes equivalent tries; and
the structural enumerations in the set are made using equivalent tries of stride 1 that are selected such that the number of structural enumerations in the set thereof is smaller than the number of tries of stride 1 in the set thereof.

12. The compressed representation set forth in claim 11 wherein:
the structural enumerations in the set include structural enumerations for tries of stride 1 in which a given rule is associated with more than one node.

13. The compressed representation set forth in claim 11 wherein:
the structural enumerations in the set include only structural enumerations for tries of stride 1 in which a given rule is associated with only one node.

14. A data storage device that is accessible to a processor, the storage device being characterized in that:
the data storage device contains code which, when executed by the processor, produces the compressed representation set forth in 6.

15. A method for making a compressed representation of a node of a trie in memory accessible to a processor, the node having a stride n>1, the node having 0 or more rules associated therewith that are accessible to the processor, and the method comprising the steps performed by the processor of:
making a structural enumeration of the node of stride n in the memory, the structural enumeration being a string that has a symbol corresponding to each node in a trie of stride 1 that corresponds to the trie of stride n and the symbol corresponding to a given node in the trie of stride 1 having a first setting if a rule of the rules is associated with the given node and a different setting if none of the rules is associated with the given node;
making a rule access list for the node of stride n in the memory whereby the rules associated with the node of stride n may be accessed, the list having an entry for accessing each of the associated rules and the entries having an order in the list that corresponds to an order of the symbols having the first setting in the structural enumeration; and
associating the structural enumeration with the rule access list.

16. The method set forth in claim 15 wherein
the processor further has access to a first set of structural enumerations; and
the method further comprises the step of:
finding the structural enumeration in the first set; and
the step of associating the structural enumeration with the rule access list is performed by associating a specifier for the structural enumeration with the rule access list.

17. The method set forth in claim 15 wherein
the processor has access to a set of structural enumerations and an equivalent set of effective enumerations, the equivalent set of effective enumerations having fewer structural enumerations than the set of structural enumerations, and to a mapping between each structural enumeration in the set of structural enumerations and an effective enumeration in the set of effective enumerations; and
the method further comprises the steps of:
finding the structural enumeration in the first set;
finding the effective enumeration that is mapped to the structural enumeration; and
the step of associating the structural enumeration with the rule access list is performed by associating a specifier for the mapped effective enumeration with the rule access list.

18. A data storage device, characterized in that:
the data storage device contains code which, when executed by a processor, performs the method set forth in claim 15.

19. A method for reading a compressed representation of a node of a trie in memory accessible to a processor, the node having a stride of n>1, the node having 0 or more rules associated therewith, the compressed representation being used to represent the node in memory accessible to a system which processes nodes of stride n, the compressed representation including
a structural enumeration for a trie of stride 1 corresponding to the node of stride n, the structural enumeration being a string which has a symbol corresponding to each node in the trie of stride 1 and the symbol corresponding to a given node in the trie of stride 1 having a first setting if a rule of the rules is associated with the given node and a different setting if none of the rules is associated with the given node; and
a rule access list whereby the associated rules may be accessed, the list having an entry for accessing each of the associated rules and the entries having an order in the list that corresponds to an order of the symbols having the first setting in the structural enumeration and
the method comprising the steps of:
receiving a key which is to be applied to the node of stride n;
using the key to locate a bit in the structural enumeration that corresponds to the node of the trie of stride 1 that corresponds to the key's value;
using the structural enumeration to determine the node of the trie of stride 1 whose rule applies to the node of the trie of stride 1 that corresponds to the key's value; and
using the structural enumeration to locate the entry for the rule in the rule access list.

20. The method set forth in claim 19 wherein
the compressed representation includes a structural enumeration specifier for the structural enumeration and
the method further comprises the step of:
using the structural enumeration specifier to obtain the structural enumeration.

21. A data storage device, characterized in that:
the data storage device contains code which, when executed by a processor, performs the method set forth in claim 19.

22. A method of reducing the size of a set of structural enumerations of tries belonging to a set of tries of stride 1, the tries of stride 1 corresponding to possible nodes of a trie of stride n>1, the nodes of stride 1 having rules associated therewith, and a structural enumeration of a trie of stride 1 being a string which has a symbol corresponding to each node in the trie of stride 1, the symbol corresponding to a given node in the trie of stride 1 having a first setting if a rule of the rules is associated with the given node and a different setting if none of the rules is associated with the given node, the method comprising the steps of:
selecting a candidate structural enumeration belonging to the set of structural enumerations;
determining whether there is a trie of stride 1 that is equivalent to the trie of stride 1 that corresponds to the candidate structural enumeration;
if there is, determining whether there is an equivalent structural enumeration in the set that corresponds to the equivalent trie of stride 1; and
if there is, removing the candidate structural enumeration from the set.

23. The method set forth in claim 22 wherein:
the steps of the method are repeated until the set of structural enumerations reaches a predetermined size.

24. The method set forth in claim 22 wherein:
in the step of selecting the candidate structural enumeration, the candidate structural enumeration is selected according to the likelihood that candidate structural enumeration will be required to decode a key.

25. The method set forth in claim 22 wherein:
in the step of selecting the structural enumeration, the structural enumeration is selected according to the number of equivalent structural enumerations that are equivalent to the candidate structural enumeration and have already been removed from the set of structural enumerations.

26. A data storage device, characterized in that:
the data storage device contains code which, when executed by a processor, performs the method set forth in claim 22.

27. A method of making a representation in memory accessible to a computer system of a node of a trie of stride n>m, the node having 0 or more rules associated therewith and m being the maximum stride for which structural enumerations are efficiently manipulatable by the computer system, the method comprising the steps performed in the computer system of:
subdividing the trie of stride n into subtries having strides≦m;
for each of the subtries with which rules are associated, obtaining a structural enumeration specifier for a structural enumeration for the subtrie that specifies the structural enumeration in a set of structural enumerations for subtries having that subtrie's stride; and
for each of the subtries, using the structural enumeration specified by the subtrie's structural enumeration specifier to make a representation of the subtrie that includes the subtrie's structural enumeration specifier and an array of specifiers for the subtrie's rules, the specifiers for the rules being ordered in the array in the same order as the symbols for the rules in the subtrie's structural enumeration.

28. The method set forth in claim 27 further comprising the steps of:
making a first data structure that contains the structural enumeration specifier for each of the subtries; and
making a second data structure that contains the array of specifiers for the rules for each of the subtries, the arrays of specifiers for the rules having the order in the second data structure that the structural enumeration specifiers have in the first data structure.

29. The method set forth in claim 27 further comprising the step performed in the computer system of:
reducing the set of structural enumerations for a particular stride such that the structural enumeration specifiers for the reduced set are efficiently manipulatable by the computer system.

30. The method set forth in claim 29 wherein:
the structural enumerations in the reduced set are structural enumerations in which each rule has exactly one symbol corresponding to the rule in the structural enumeration.

31. The method set forth in claim 29 wherein:
in the step of reducing the set of structural enumerations, a cost function is employed to determine which structural enumerations are removed.

32. The method set forth in claim 31 wherein:
the cost function takes into account a likelihood that a structural enumeration to be removed will be required to decode a key.

33. The method set forth in claim 31 wherein:
the cost function takes into account the number of equivalent structural enumerations that are equivalent to the candidate structural enumeration and have already been removed from the set of structural enumerations.

34. A data storage device, characterized in that:
the data storage device contains code which, when executed by a processor, performs the method set forth in claim 27.
